(19) United States
(12) Patent Application Publication
(10) Pub. No.: US 2013/0038607 A1
(43) Pub. Date: Feb. 14, 2013

(54) TIME LINE OPERATION CONTROL DEVICE, TIME LINE OPERATION CONTROL METHOD, PROGRAM AND IMAGE PROCESSOR

(71) Applicant: Sensaburo NAKAMURA, Kanagawa (JP)

(72) Inventor: Sensaburo NAKAMURA, Kanagawa (JP)

(21) Appl. No.: 13/568,819

(22) Filed: Aug. 7, 2012

(30) Foreign Application Priority Data
Aug. 12, 2011 (JP) 2011-177230

(51) Int. Cl. G06T 13/00; G06T 15/04

(52) U.S. Cl. 345/419; 345/473

(57) ABSTRACT

There is provided a time line operation control device including a time line holding section that holds a time line which is a prescription of a time-series changing control, a meta time line holding section that holds a meta time line prescribing a progression path on the time line, and a control section that progresses time on the time line representing a position on the time line in accordance with the progression path on the time line prescribed in the meta time line to thereby control the time line operation in accordance with the progression.

### BACKGROUND

The present technology relates to a time line operation control device, a time line operation control method, a program and an image processor. In particular, the present technology relates to a time line operation control device and the like suitable for, for example, a use for operating a CG (computer graphics) image in a live program.

In producing a CG, a state of CG of plural key-frames is determined on a time line. When creating a CG image, a state of CG at every points of time on the time line is determined by interpolating between the key-frames to thereby generate images for the respective frames. In this case, same as recording a video material, the CG images can be reproduced, fast-fed, rewound etc; and the CG images can be desirably operated to progress to shift on the time line to output images as an animation.

For example, Japanese Unexamined Patent Application Publication No. 2005-196669 teaches a technique of creating a GUI (graphical user interface); in which, using CG data according to the time line, jump of time is made on a time line responding to an operation event. In this case, desired positions on the time line are marked using, labels, and event processing rules define the jumps to the labels.

In devices for making special effects on a video, a like technique which uses key-frames is known. FIG. 33 illustrates a progression example of a special effect using interpolation. Referring to these figures, a larger frame represents a picture; smaller frames therein represent sub pictures; and the position and size of the sub pictures are changed. FIG. 33A illustrates an original state; and FIG. 33B and FIG. 33C illustrate a shifted state respectively. In this case, the original state and a shifted state are handled as key-frames, and a transition therebetween is made by performing interpolation using parameters.

### SUMMARY

There is widely known an editing method using the time line, in which images are reproduced by editing CGs or video special effects. The time line enables to achieve complicated time-series motions. A CG real time rendering device enables to obtain images in which the contents of a CG are modified by operating the same.

However, highly complicated operation is hardly achieved by operating parameters of a CG (for example, TRS: position/rotation/enlargement/reduction) while reproducing a live program. Although it is difficult, but by operating two joy joysticks, TRS operation is possible on two virtual objects. However, desired effects are extremely difficult to obtain.

The disclosure enhances the operability of complicated time-series motions.

A concept of the present technology is a time line operation control device, which includes: a time line holding section that holds a time line which is a prescription of a time-series changing control; a meta time line holding section that holds a meta time line prescribing a progression path on the time line; and a control section that progresses the time on the time line indicating a position on the time line in accordance with a progression path on the time line prescribed in the meta time line to thereby control the time line operation in accordance with the progression.

In the present technology, the time line holding section holds a time line which is a prescription of time-series changing control. The meta time line holding section holds a meta time line which prescribes a progression path on the time line. For example, the progression path on the time line prescribed in the meta time line may include a time-jump of the time line. Also, for example, progression path on the time line prescribed in the meta time line may include a progression path which reverses the time axis of the time line.

The control section progresses the time on the time line which represents a position on the time line in accordance with the progression path on the time line prescribed in the meta time line to thereby control the time line operation in accordance with the progression. For example, the time on the time line is adapted so as, when an instruction is given to play the meta time line, to change a value designated to the head of the meta time line. Also, or example, when the time on the time line between key-frame points on the time line, parameters of the time on the time line are interpolated using parameters of the proceeding and following key-frames to thereby determine the control. Further, for example, the meta time line holding section holds a plurality of meta time lines, and the control section controls the process based on a selected one of the meta time lines.

Thus, in the present technology, the time on the tune line which represents a position on the time line progresses in accordance with the progression path on the time line prescribed in the meta time line which is held by the meta time line holding section, and the time line operation is controlled in accordance with the progression. Therefore, the operability of complicated time-series actions can be enhanced.

In the present technology, for example, the control section may be configured to progress the time on the time line which represents a position on the time line in accordance with the progression path on the time line prescribed in the meta time line and a user designation speed to thereby control the time line operation in accordance with the progression. For example, the user designation speed may be previously designated through a speed designation operation made by the user and held in the memory of the control section.

In the present technology, for example, the progression path on the time line prescribed in the meta time line may include a predetermined number of sections each including a preset speed. The control section may progress the time on the time line which represents a position on the time line based on the progression path on the time line prescribed in the meta time line and the preset speed of each section to thereby control the time line operation in accordance with the progression.

In the present technology, for example, the progression path on the time line prescribed in the meta time line may include a predetermined number of sections each including a preset speed. The control section may progress the time on the time line which represents a position on the time line based on the progression path on the time line prescribed in the meta time line, the presets speed of each section and a user designation speed to thereby control the time line operation in accordance with the progression.

In the present technology, for example, a meta time line creating support section is further included for supporting the creation of meta time line. The meta tune line creating support section detects identical contents with respect to a plurality of key-frame points in the time line, and provides the same as an option of a progression start point of a meta time line.

In the present technology, for example, the time on the time line which representing a position on the time line may be progressed in accordance with the progression path on the time line prescribed in the meta time line and the a fader value given by an operation of the fader lever to thereby control the time line operation in accordance with the progression.

Another concept of the present technology is an image processor, which includes: an image generating section that generates an image based on a piece of computer graphics prescription data including a time line operation; a meta time line holding section that holds a meta time line prescribing a progression path on the time line; and a control section that progresses the time on the time line representing a position on the time line in accordance with the progression path on the time line prescribed in the meta time line to thereby control the image generating section to play a part of the time line in accordance with the progression.

In the present technology, the image generating section generates an image based on a piece of computer graphics prescription data including the time line operation. The meta time line holding section holds a meta time line which prescribes a progression path on the time line. For example, the meta time line holding section holds a plurality of meta time lines. Head of the plurality of meta time lines is, for example, a time when the computer graphics spaces are identical to each other on the time line and/or a time when the input images to be texture-mapped are full-pictures.

The control section progresses the time on the time line which represents a position on the time line in accordance with the meta time line, and controls the image generating section to play a part of the time line in accordance with the progression. With this, the operability of complicated time-series operations for generating CG image can be enhanced.

In the present technology, for example, the control section may be configured as below. That is, when heads of the plurality of meta time lines is a time when computer graphics spaces are identical on the time line and/or a time when the input images to be texture-mapped are full-pictures, and when an instruction is given to switch from a first meta time line in play to a second meta time line, the control section switches the first meta time line to the second meta time line when the first meta time line reaches the head thereof. In this case, when switching the meta time line, a CG can be changed smoothly with no jump in the image.

In the present technology, for example, the control section may be configured as below. That is, when heads of the first meta time line and second head of the meta time line are a time when the input images to be texture-mapped on the time line are full-pictures, the control section controls to a texture-mapping image to the image generating section so that the input images to be texture-mapped are identical to each other when switching from a first meta time line in play to a second meta time line. In this case, the meta time line can be switched without causing any changes on the input image.

According to the present technology, the operability of complicated time-series operation can be enhanced.

### BRIEF DESCRIPTION OF THE DRAWINGS

FIG. 1 is a block diagram illustrating an example of a configuration of an image processor according to a first embodiment of the present technology;

FIG. 2 illustrates an example of a time-series motion of CG in accordance with the time line;

FIG. 3 illustrates an example of a time-series motion of CG by playing a part of the time line;

FIG. 4 illustrates an example of GUI in creating/editing of meta time line;

FIG. 5 illustrates an example of a meta time line held by a meta time line holding section;

FIG. 6 is an illustration of progression and reverse of the time on the time line in the meta time line indicating with arrows;

FIG. 7 is an illustration showing a time-series operation of a CG by playing a part of the time line in a meta time line;

FIG. 8 is a flowchart showing an example of a control operation of an image generating section made by a control section;

FIG. 9 is a flowchart showing another example of the control operation on the image generating section made by the control section;

FIG. 10 is a flowchart showing the control operation by the image generating section in the control section when a fader lever is operated;

FIG. 11 illustrates another example of the meta time line held by the meta time line holding section;

FIG. 12 is a flowchart showing an example of the control operation on the image generating section by the control section when the meta tit line has speed information for each section;

FIG. 13 is a flowchart showing an example of a control operation on the image generating section by the control section when the time of the end time code of a section is simultaneous with the time of start time code in the next section;

FIG. 14 is a flowchart showing an example of a control operation on the image generating section by the control section when the meta time line has a piece of speed information fore each section;

FIG. 15 is a block diagram showing a configuration example of an image processor as a second embodiment of the present technology;

FIG. 16 illustrates an example of the meta time line held by the meta time line holding section;

FIG. 17 illustrates an example of the GUI for creating/editing of the meta time line;

FIG. 18 illustrates an example of the GUI when “add” button or “edit” button is pressed by the user;

FIG. 19 illustrates an example of exterior (operation plane) of a switcher console;

FIG. 20 illustrates an example of a configuration of an M/E bank of an effect switcher;

FIG. 21 illustrates a control of cross points to take an input in which the effect switcher receives an image signal from the image generating section while playing a CG into a use keyer “Key1”;

FIG. 22 illustrates an example of a relationship between a fader value and a progression on a meta time line;

FIG. 23 illustrates a selection of the meta time line using a cross-point button row;

FIG. 24 is a flowchart (1/2) showing a control operation of the switcher console (control section) when a meta time line is designates as a transition type;

FIG. 25 is a flowchart (2/2) showing a control operation of the switcher console (control section) when a meta time line is designates as a transition type;

FIG. 26 schematically shows an example of an operation to switch from a meta time line in action;

FIG. 27 illustrates an example of a time line display when switching a meta time line in action;

FIG. 28 illustrates an example of a CG virtual space;

FIG. 29 illustrates an example of a meta time line;

FIG. 30 is a flowchart (1/2) showing a control operation to switch the meta time line by the switcher console (control section) when On/Off of “keep full-picture content” is set as option;

FIG. 31 is a flowchart (2/2) showing a control operation to switch the meta time line by the switcher console (control section) when On/Off of “keep full-picture content” is set as option;

FIG. 32 illustrates a method to make a transition by using states in which areas of an input image in a picture (texture-mapped areas) are identical to each other; and

FIG. 33 illustrates an example of progression of a special effect made by an interpolation.

### DETAILED DESCRIPTION OF THE EMBODIMENT(S)

Embodiments of the present disclosure (hereinafter, referred to as “embodiment”) will be described below. The description will be made in the following order.

1. First embodiment

2. Second embodiment

3. Modification

### 1. First Embodiment

[Configuration of CG Image Generation Apparatus]

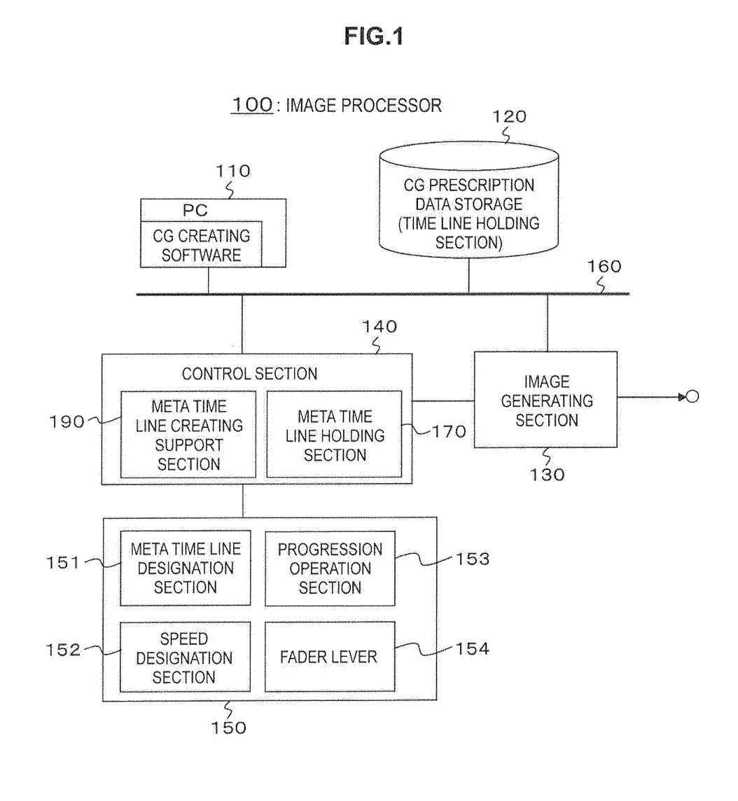

FIG. 1 illustrates an example of a configuration of a first embodiment of an image processor 100 according to the present technology. The image processor 100 includes a CG (computer graphics) creating section 110, a CG prescription data storage 120, an image generating section 130, a control section 140, a user operation section 150, and a network 160. The CG creating section 110, the CG prescription data storage 120, the image generating section 130 and the control section 140 are connected to each other via the network 160.

The CG creating section 110 is configured including a personal computer (PC) which has a CG creating software. The CG creating section 110 outputs CG prescription data of a predetermined format. As a format of the CG prescription data, for example, Collada (registered trademark) is applicable. The Collada is a prescription definition for enabling 3D CG data to be exchanged on an extensible markup language (XML). The CG prescription data is capable of writing, for example, various kinds of information as listed below.

(a) Definition of material (surface mode)

Definition of material defines a quality (hue) of the surface of a CG object. The material definition includes various kinds of information such as color, mode of reflection, light emission, concavity and convexity and the like. The material definition may include a piece of information on texture-mapping. As described above, the texture-mapping is a technique to attach an image to a CG object, which enables complicated patterns and the like to be presented while relatively reducing a load on the processing system.

(b) Definition of geometry information

The definition of geometry information includes a piece of information on polygon mesh such as positional coordinates, vertex coordinates or the like.

(c) Definition of camera

The definition of camera includes parameter of camera.

(d) Definition of animation

The definition of animation includes various kinds of information in each key-frame of an animation. The definition of animation also includes a piece of information of time in each key-frame the animation. “Various kinds of information” here includes various kinds of information, for example, a point of time of a key-frame corresponding to an object (node), coordinate values of position and vertex, size, tangent vector, interpolating method, changes in animation and the like.

(e) Position, direction, size of a node (object), definition of corresponding geometry information, and definition of corresponding material in a scene.

The above various kinds of information are not separated from each other, but are associated with each other as below, for example;

node . . . geometry information

node . . . material (plural)

geometry information . . . polygon set (plural)

polygon set . . . material (one of materials corresponding to nodes)

animation . . . node

One description which configures one picture is referred to as scene. Each definition is referred to as library. Each scene refers to the library. For example, when two objects of rectangular parallelepipeds are included in a scene, each of the two objects is written as an independent node; and each of which is connected to any one of the material definitions. As a result, each of the rectangular parallelepiped objects is connected to material definitions, and each of which is drawn into an image using colors and reflection characteristics in accordance with the relevant material definitions.

Or, each of the objects of rectangular parallelepipeds is written with plural polygon sets. When material definitions are connected to the plural polygon sets, each of the plural polygon sets is drawn into an image using different material definitions. For example, when a rectangular parallelepiped having six planes; there may be a case in which the rectangular parallelepiped is written by using three polygon sets; i.e., three planes are written by using one polygon set; one plane is written by using one polygon set; and two planes are written by using one polygon set. Since different material definitions are connected to each polygon set, it is possible to draw an image which has six planes each painted with different colors.

When texture-mapping is specified to the material definition, on each of the planes of the connected object, an image is texture-mapped based on image data thereof.

For example, a material definition is set to map with a texture on an image. Therefore, an image may be mapped with an identical texture on every planes of a rectangular parallelepiped object; or every plane may be mapped with different images.

The CG prescription data storage 120 stores a predetermined number of CG prescription data generated by the CG creating section 110. The CG prescription data includes a time line (description of time-base control of changes) of an original animation. With this, the CG prescription data storage 120 configures a time line holding section. The image generating section 130 generates a CG image which is a. 3-D virtual image based on the CG prescription data stored in the CG prescription data storage 120.

The control section 140 controls the operations made by the respective sections of the image processor 100. The control section 140 includes a meta time line holding section 170. The location of the meta time line holding section 170 is not limited to the inside of the control section 140, but may be located, for example, in another storage connected thereto via the network 160.

The meta time line holding section 170 holds a predetermined number of meta time lines (channel program) each of which prescribes a progression path on the time line. The meta time line plays a part of the time line. The meta time line may include a time-jump within the progression path on a time line prescribed by the meta time line. As the progression path on the time line prescribed in the meta time line, the progression path may reverse with respect to the time axis of the time line.

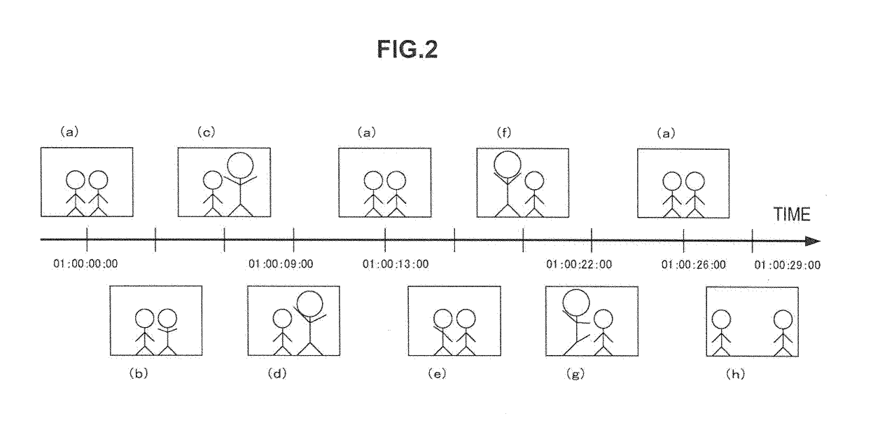

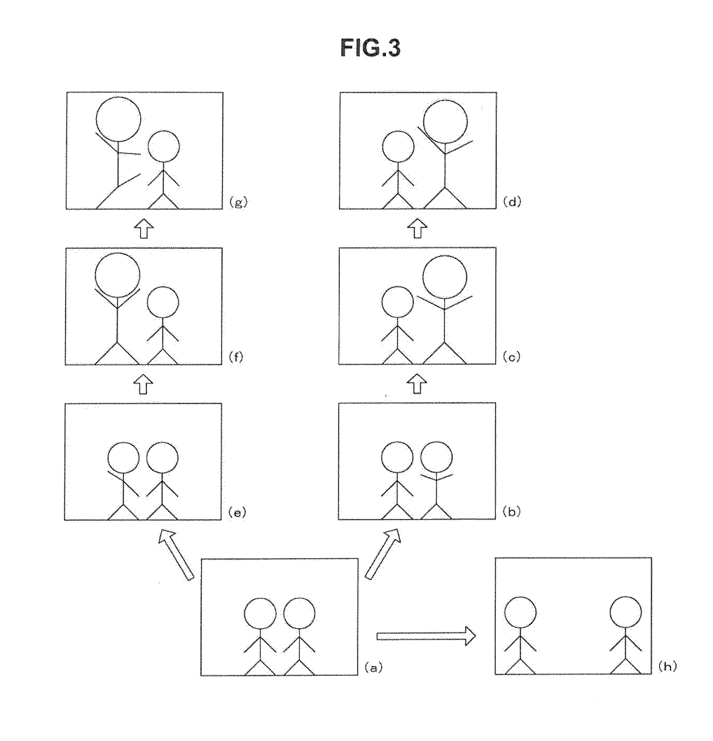

FIG. 2 illustrates an example of a time-series motion (changes of image) of a CG with respect to the time line. FIG. 3 illustrates an example of a time-series motion (changes of image) of a CG by playing a part of the time line. For example, a meta time line plays a time-series motion of a CG like (a)→(e)→(f)→(g). Also, another meta time line plays a time-series motion of the CG, for example, (a)→(b)→(e)→(d). Also, still another meta time line plays a time-series motion of the CG, for example, (a)→(b).

A desired meta time line is designated to play from plural meta time lines held by the meta time line holding section 170. In this case, a user is allowed to desirably select the progression from an initial state of a CG (refer to a state FIG. 2A) to one of plural other states (states of the CG content has shifted) during reproducing the CG. In the plural meta time lines held by the meta time line holding section 170, a point of time when identical CG space exists on the time line is the start point of the respective time lines. These start points are “01:00:00:00”, “01:00:13:00”, “01:00:26:00”, which are indicated with (a) in FIG. 2.

The meta time lines which are held by the meta time line holding section 170 are created by, for example, the control section 140, or by other unit, for example, by a personal computer or the like which has a software for creating meta time line and is connected to the network 160. For example, the control section 140 includes a meta tune line creating support section 190. The meta time line creating support section 190 functions to detect identical items at plural key-frame points on the time line to provide options of start point of a progression of a meta time line.

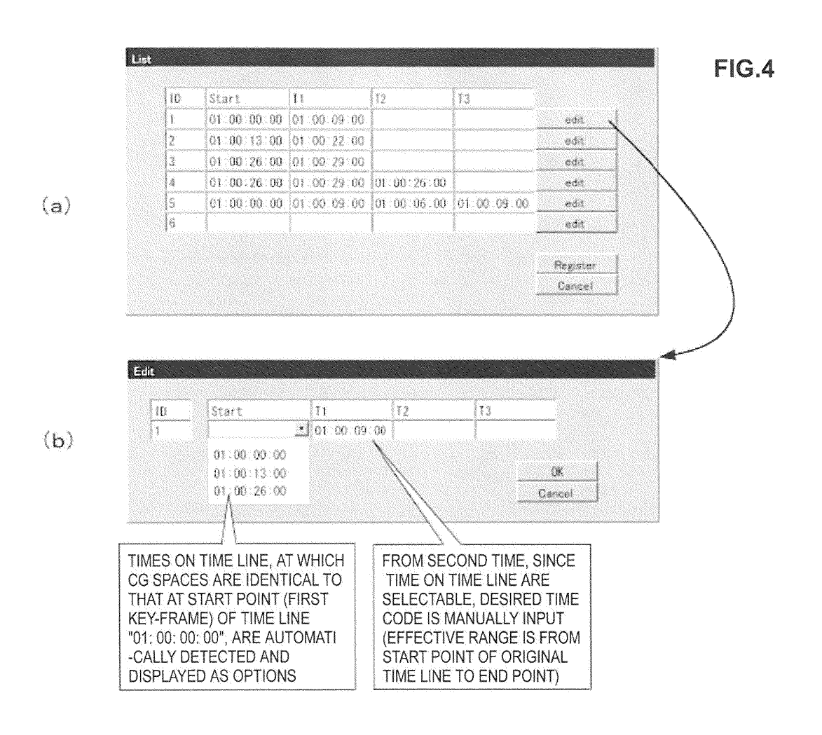

FIG. 4 illustrates an example of a GUI (graphical user interface) for creating/editing meta time line. FIG. 4A shows a list of meta time lines. After selecting one of predetermined IDs from the meta time lines, by pressing edit button “edit”, the meta time line corresponding to the ID can be edited; i.e., newly created or changed. FIG. 4B shows an example of the GUI in edit mode. In the GUI, an ID of the meta time line to be edited is displayed.

Under the edit mode of the GUI, times on the time line, at which the CG spaces are identical to that at the start point (first key-frame) “01:00:00:00” on the time line, are automatically detected and displayed as options. Also, under the edit mode of the GUI, since the time on the time line are selectable from the second time, the user is allowed to manually input desired time code through the user operation section 150. The elective range in this case is from the start point of the original time line to the end point thereof.

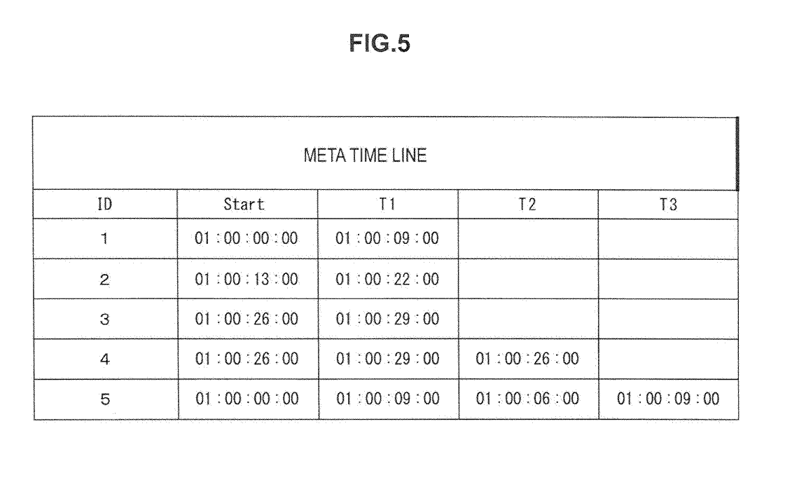

FIG. 5 shows an example of meta time lines held by the meta time line holding section 170. In this example, five meta time lines with ID 1-5 are included. For example, in the meta time line with ID=1, the meta time line starts at the time “01:00:00:00” on the time line, after progressing up to the time “01:00:09:00” on the time line, terminates at the point of “01:00:09:00”. Also, for example, in the meta time line with ID=4, the meta time line starts at the time “01:00:00:00” on the time line, and progresses up to the time “01:00:09:00” on the time line. Further, in the meta time line with ID=4, the meta time line regresses from the time “01:00:09:00” on the time line up to the time on the time line “01:00:26:00”, and terminates at the time “01:00:09:00” on the time line.

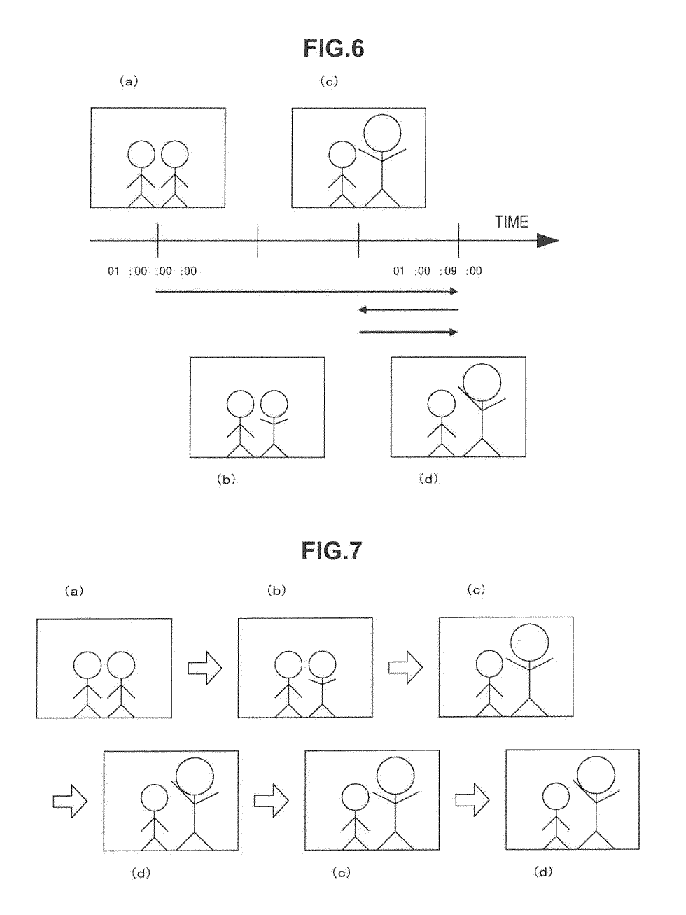

Also, for example, in the meta time line with ID=5, the meta time line starts at the time “01:00:00:00” and progresses up to the time “01:00:09:00” on the time line; and subsequently regresses from the time “01:00:09:00” up to the time “01:00:06:00” on the time line. Further, in the meta time line with ID=5, the meta time line progresses from the time “01:00:06:00” and terminates at the time “01:00:09:00” on the time line. FIG. 6 illustrates the progression and reverse of the time on the meta time line with ID=5 indicating with arrows. FIG. 7 illustrates a time-series motion (changes of image) of a CG by playing a part of time line using the meta time line ID=5.

Referring to FIG. 1 again, the user operation section 150 configures a user interface. The user operation section 150 is connected to the control section 140. The user is allowed to operate the user operation section 150 to perform various operations. The user operation section 150 includes, for example, a meta time line designation section 151, a speed designation section 152, a progression operation section 153, a fader lever 154 and the like.

The meta time line designation section 151 allows the user to use for designating a meta time line to be played from the predetermined number of meta time lines held by the meta time line holding section 170. The speed designation section 152 allows the user to designate the speed of the progression or reverse of the time on the time line. In other word, the speed designation section 152 is used to obtain user designation speed.

The speed designation operation is performed by, for example, designating a coefficient which represents a magnification with respect to the ordinary speed. The user designation speed (coefficient) is reflected to the entire of the meta time line designated by the meta time line designation section 151. The user designation speed (coefficient) is held in, for example, an unshown memory in the control section 140. The user designation speed may not be an integer. The unit (control method) is configured to hold a decimal part so that the time on the time line in progression may include a fractional point.

The progression operation section 153 is used by the user to operate the play of the meta time line designated by the meta time line designation section 151. When an operation is made to play the meta time line, the control section 140 controls the image generating section 130 to progress the time on the time line representing the position on the time line in accordance with the meta time line to play a part of the time line in accordance with the progression.

The fader lever 154 is used by the user, for example, make progress the time on the time line in the meta time line designated by the meta time line designation section 151. When the fader lever 154 is swung, the parameter (fader value) changes from 0% to 100%. The control section 170 makes the time on the time line representing the position on the time line to progress in accordance with the meta time line and the parameter.

It is assumed a case in which, for example, the meta time line starts from “01:00:00:00” and terminates at “01:00:09:00”. At a point when the meta time line is selected, the control section 140 controls the image generating section 130 to generate a CG image at “01:00:00:00”. When the fader lever 154 is swung, the meta time line progresses toward “01:00:09:00” which is 100%. Because even a fractional point can obtain a corresponding parameter by interpolation, the time on the time line in progression may not be frame/field unit, but may be a fractional point.

When the fader lever 154 is positioned at 100%, the CG image at “01:00:09:00” is generated. Then, the fader lever 154 is returned, the CG gradually regresses on the tune line, to the CG image at “01:00:00:00” of 0%.

By selecting the meta time line and by using the fader lever 154, a desired option is selected from plural options at the initial state of the CG; to thereby cause the CG to perform complicated variations. By returning the fader lever 154, the CG is gradually returned, to the initial state; or by calling the meta time line, the CG is gradually returned instantly to the initial state, and is set to a standby state for next selection.

For example, assuming now that, with a live background image of a discussion made by plural persons (robots) in a studio, a CG image is being superimposed therewith; in the progression of the discussion, any one of the persons is take in a picture close up. By selecting an option to enlarge the person (robot) in the CG corresponding to the person and by operating the fader lever 154 along with this progression of the discussion, the variations of the CG can be synchronized with the changes in the discussion.

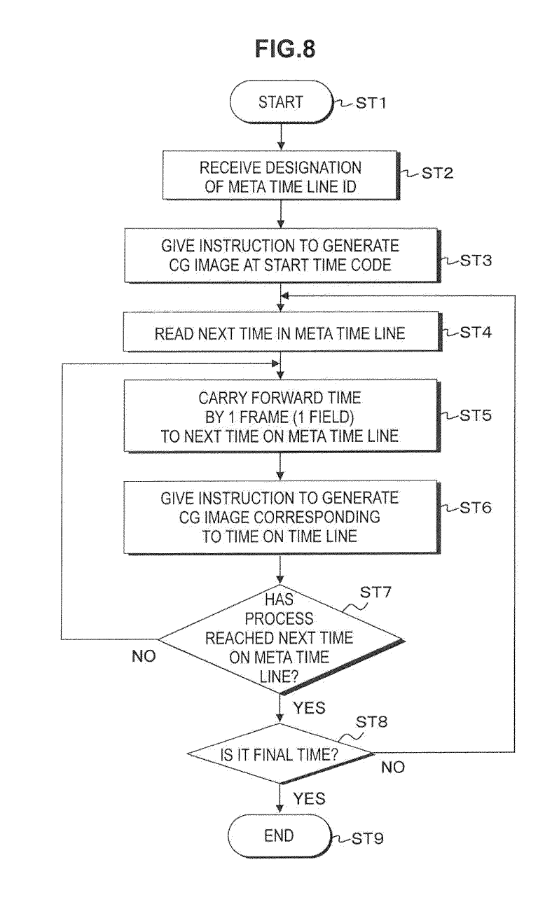

FIG. 8 is a flowchart showing an example of a control operation of the image generating section 130 made by the control section 140. In step ST1, the control section 140 starts the control operation, and then progresses to the process of step ST2. In step ST2, the control section 140 receives a designation of a meta time line ID from the user through an operation of the meta time line designation section 151. With this, the control section 140 gets into a controllable state of the operation in accordance with the meta time line corresponding to the designated meta time line ID in the predetermined number of meta time lines held by the meta time line holding section 170.

In step ST3, the control section 140 gives an instruction to the image generating section 130 to generate a CG image at a start time code of the meta time line. In step ST4, the control section 140 reads the next time on the meta time line. For example, in the case of meta time line ID=4 shown in FIG. 5, the start time code is “01:00:26:00”; and the next time is “01:00:29:00”.

Subsequently in step ST5, according to the progression of actual time frame (field), the control section 140 progresses the time on the time line by 1 frame (1 field) to the next time on the meta time line. In step ST6, the control section 140 gives an instruction to the image generating section 130 to generate a CG image corresponding to the time on the time line. Here, when the time on the time line is not a key-frame, the control section 140 interpolates the parameter of the time on the time line using parameters of the proceeding and the following key-frames on the time line to determine the control on the image generating section 130.

In step ST7, the control section 140 determines whether the process reaches the next time on the meta time line. When the process does not reach the next time, the control section 140 returns to step ST5 and repeats the same process above. On the other hand, when the process reaches the next time, the control section 140 progresses to the process of step ST8.

In step ST8, it is determined whether the process is the final time. For example, in the case of the meta time line of meta time line ID=4 shown in FIG. 5, when the time is “01:00:29:00”, the next time is not the final time; when the next time is “01:00:26:00”, the next time is the final time. When the time is not the final time, the control section 140 returns to the process of step ST4 and repeats the same process above. On the other hand, when the process is final time, the control section 140 terminates the control processing at step ST9.

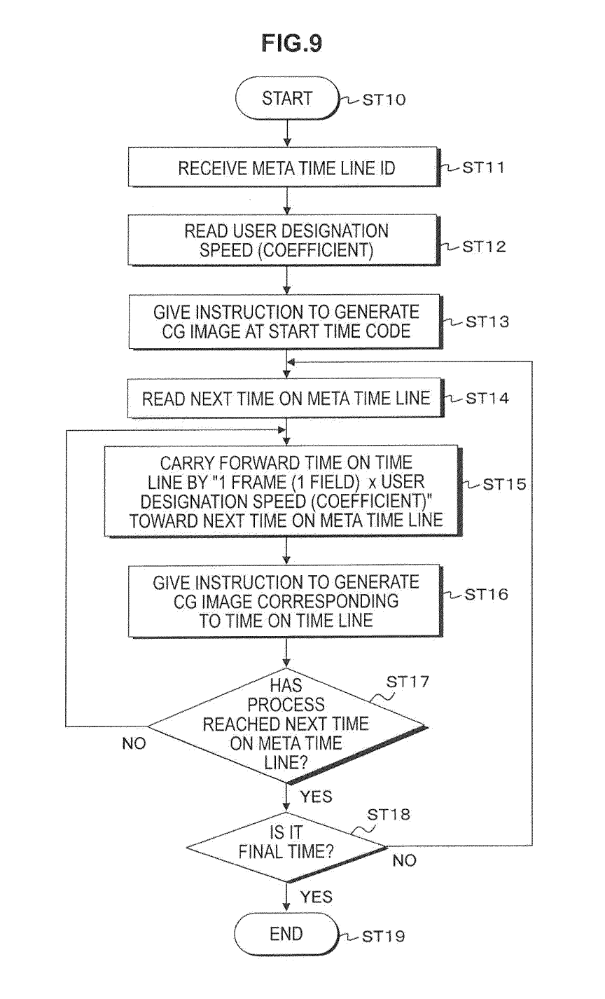

The above control operation in the flowchart in FIG. 8 shows the case when no speed designation is given by the user through the speed designation section 152. When a speed designation is given by the user, the control operation made by the control section 140 on the image generating section 130 is shown in the flowchart in FIG. 9.

In step ST10, the control section 140 starts the control operation, and then processes to step ST11. In step ST11, the control section 140 receives a designation of a meta time line ID given by the user through the operation on the meta time line designation section 151. With this, the control section 140 gets into a controllable state in accordance with the meta time line corresponding to the designated meta time line ID in the predetermined number of meta time lines held by the meta time line holding section 170.

In step ST12, the control section 140 reads a user designation speed (coefficient). As described above, for example, the speed designation operation is previously made by the user through the speed designation section 152, and the user designation speed (coefficient) is held in the memory of the control section 140. In step ST12, the control section 140 reads the speed designation value held in the memory.

In step ST13, the control section 140 gives an instruction to the image generating section 130 to generate a CG image at the start time code (start time) on the meta time line. In step ST14, the control section 140 reads the next time on the meta time line. For example, in the case of the meta time line ID=4 shown in FIG. 5, the start time code is “01:00:26:00”, and the next time is “01:00:29:00”.

In step ST15, the control section 140 progresses the time on the time line by “1 frame (1 field)×user designation speed (coefficient)” toward the next time on the meta time line. In step ST16, the control section 140 gives an instruction to the image generating section 130 to generate a CG image corresponding to the time on the time line (a value which may include a fractional point). Here, when the time on the time line is not a key-frame, the control section 140 interpolates the parameters of the time on the time line using parameters of the proceeding and following key-frames on the time line to thereby determine the control on the image generating section 130.

In step ST17, the control section 140 determines whether the process has reached the next time on the meta time line. When the process has not reached the next time, the control section 140 returns to step ST15 and repeats the same process above. On the other hand, when the process has reached the next time, the control section 140 progresses to the process of step ST18.

In step ST18, the control section 140 determines whether the next time is the final time. For example, in the case of the meta time line ID=4 shown in FIG. 5, when the next time is “01:00:29:00”, the next time is not the final time; and when the next time is “01:00:26:00”, the next time is the final time. When the next time is not the final time, the control section 140 returns to the process of step ST14 and repeats the same process above. On the other hand, when the next time is the final time, the control section 140 terminates the control processing in step ST19.

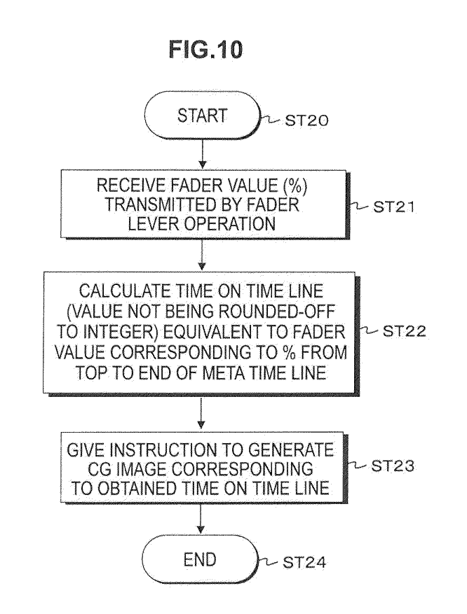

Subsequently, referring to the flowchart of FIG. 10, a description will be given about the control operation on the image generating section 130 made by the control section 140 when the fader lever 154 is operated. In step ST20, the control section 140 starts the control operation, and progresses to the process of step ST21. In step ST21, the control section 140 receives a fader value (%) transmitted by the fader lever operation through the user operation section 150.

In step ST22, the control section 140 calculates the time on the time line (a value not being rounded-off to an integer) equivalent to the fader value corresponding to % from the top to the end of the meta time line. In step ST23, the control section 140 gives an instruction to the image generating section 130 to generate a CG image corresponding to the obtained time on the time line. After performing the process of step ST23, the control section 140 terminates the control operation in step ST24.

As described above, in the image processor 100 shown in FIG. 1, the control section 140 progresses the time on the time line representing the position on the time line according to the meta time line designated by the user. The control section 140 controls the CG image generating operation (time line operation) in the image generating section 130 in accordance with the progression.

As described above, the progression path on the time line prescribed in the meta time line may include a time-jump of the time line therein. Also, as described above, as the progression path on the time line prescribed in the meta time line, the time axis of the time line may include a progression path to reverse thereon. When the progression path on the time line prescribed in the meta time line includes a predetermined number of sections, each section may include preset speeds. Thus, the operability of complicated time-series operations is enhanced.

The image processor 100 shown in FIG. 1 allows the user to desirably designate and adjust the progression or reversing speed of the time on the time line using the speed designation section 152 in the user operation section 150. In this case, the control section 140 progresses the time on the time line representing the position on the time line in accordance with the meta time line and the designation speed designated by the user, to thereby control the CG image generating operation (time line operation) by the image generating section 130 in accordance with the progression.

[Meta Time Line (Including Preset Speed)]

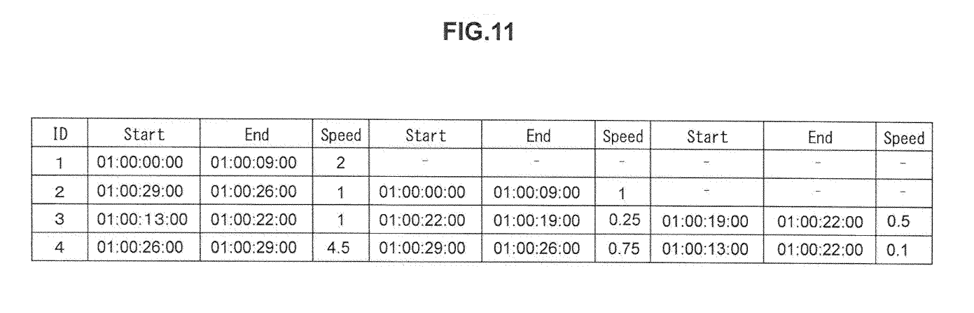

The above-described meta time line has a piece of time information as a prescription of the progression path on the time line (refer to FIG. 5). The meta time line may further include a piece of speed information. FIG. 11 shows an example of the meta time line in this case held by the meta time line holding section 170. Each meta time line includes a predetermined number of sections.

In this example, there are four meta time lines of IDs 1-4. For example, the meta time line of ID=1 has a single section in which the start time code (start time) is “01:00:00:00”; and the end time code (end time) is “01:00:09:00”. In the meta time line of ID=1, the preset speed (Speed) of the section is set to “2”. The preset speed is a coefficient representing, for example, the magnification with respect to the ordinary speed same as the user designation speed.

For example, the meta time line of ID=3 includes a first section, a second section and a third section. The first section includes a start time code (representing a start time of the section) of “01:00:13:00”; and an end time code (representing the end time of the section) of “01:00:22:00”, and the preset speed (Speed) of the section is set to “1”.

The second section includes a start time code of “01:00:22:00”, and an end time code of “01:00:19:00”; and a preset speed (Speed) of the section is set to “0.25”. The second section is a section in which the tune axis of the time line is reversed. The third section includes a start time code of “01:00:19:00”, an end time code of “01:00:22:00”; and a preset speed (Speed) of the section is set to “0.5”.

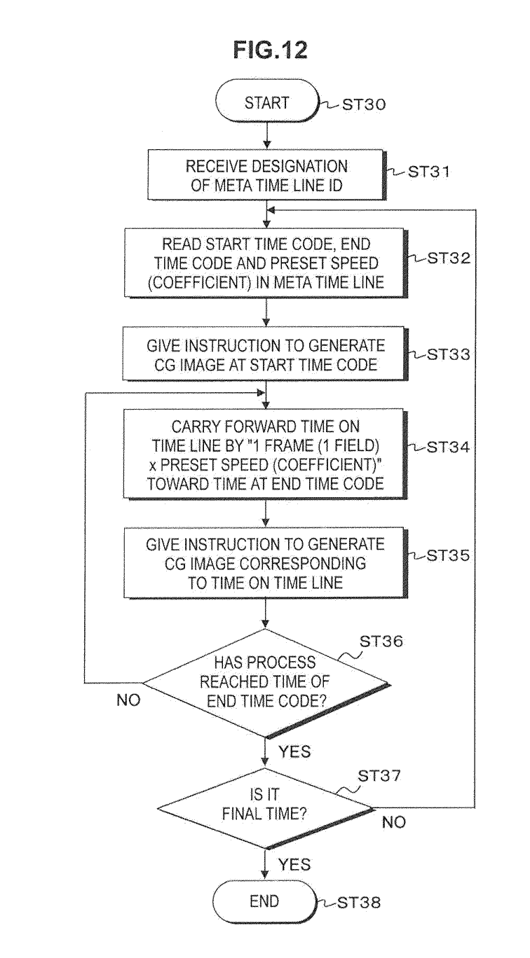

A flowchart in FIG. 12 shows an example of a control operation of the image generating section 130 made by the control section 140 in the case, as described above, the meta time line includes a piece of speed information for each section. In step ST30, the control section 140 starts the control operation, and then proceeds to the process in step ST31.

In step ST31 the control section 140 receives a designation of the meta time line ID through the operation made by the user on the meta time line designation section 151. With this, the control section 140 gets into controllable state of the operation in accordance with the meta time line corresponding to the designated meta time line ID in the predetermined number of the meta time lines held by the meta time line holding section 170.

In step ST32, the control section 140 reads the start time code, the end time code and the preset speed (coefficient) of the first section in the meta time line. In step ST33, the control section 140 gives an instruction to the image generating section 130 to generate a CG image at the start time code.

In step ST34, the control section 140 progresses the time on the time line by “1 frame (1 field)×preset speed (coefficient)” toward the time at the end time code. In step ST35, the control section 140 gives an instruction to the image generating section 130 to generate a CG image corresponding to the time on the time line. Here, when the time on the time line is not a key-frame, the control section 140 interpolates the parameters of the time on the time line using the parameters of the proceeding and following key-frames on the time line to determine the control on the image generating section 130.

In step ST36, the control section 140 determines whether the process has reached the time of the end time code. When the process has not reached the time of the end time code, the control section 140 returns to step ST34, and repeat the same process above. On the other hand, when the process has reached the time of the end time code, the control section 140 precedes to the process in step ST37.

In step ST37, the control section 140 determines whether it is the final time in the meta time line. For example, in the case of the meta time line the meta time line of ID=1 shown in FIG 11, the final time is “01:00:09:00”. Also, for example, in the case of the meta time line ID=3 shown in FIG. 11, the final time is the “01:00:22:00” in the third section. When it is not the final time, the control section 140 returns to the process of step ST32, reads the start time code, the end time code and the preset speed (coefficient) of the next section and repeats the same process above. On the other hand, when it is the final time, the control section 140 terminates the control processing in step ST38.

As described above, since the meta time line has a preset speed (speed information) for each section, the changing speed of the progression (reverse) of the time on the time line corresponds to the preset speed of each section. Thus, the control section 140 can perform further complicated time line control operation.

The flowchart in FIG. 12 shows the example of the control operation in which, when the meta time line includes plural sections, the time of the end time code of a section does not superimposes with the time at the start time code in the next section. The control section 140 is configured to give an instruction to the image generating section 130 to generate a CG image at the time of the end time code of a section, and then to give an instruction to the image generating section 130 to generate a CG image at the time of the start time code in the next section. The meta time line shown in FIG. 11 shows an example of the case the time of the end time code in a section superimposes with the time at the start time code in the next section.

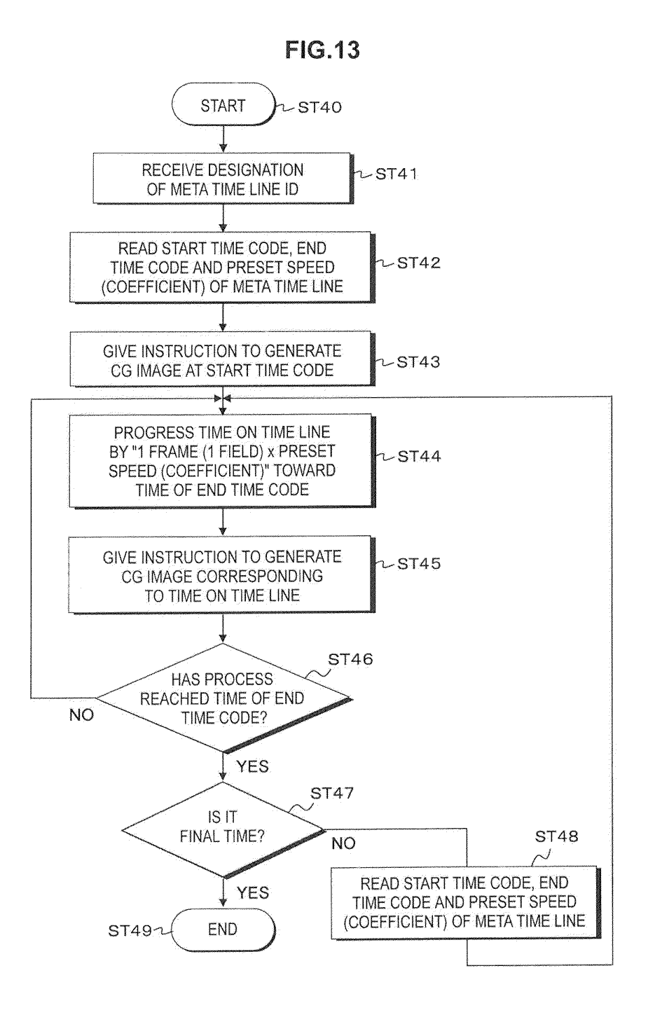

The flowchart in FIG. 13 shows an example of the control operation on the image generating section 130 made by the control section 140 to control so that the time of the end time code of a section superimposes with the time at the start time code in the next section. In step ST40, the control section 140 starts the control operation and then proceeds to the process in step ST41.

In step ST41, the control section 140 receives a designation of the meta time line ID through the operation made by the user on the meta time line designation section 151. With this, the control section 140 gets into a controllable state of the operation in accordance with the meta time line corresponding to the designated meta time line ID in the predetermined number of meta time lines held by the meta time line holding section 170.

In step ST42, the control section 140 reads a start time code, an end time code and a preset speed (coefficient) in the first section of the meta time line. In step ST43, the control section 140 gives an instruction to the image generating section 130 to generate a CG image at the start time code.

In step ST44, the control section 140 progresses the time on the time line by “1 frame (1 field)×preset speed (coefficient)” toward the time of the end time code. In step ST45, the control section 140 gives an instruction to the image generating section 130 to generate a CG image corresponding to the time on the time line. Here, when the time on the time line is not a key-frame, the control section 140 interpolates the parameters of the time on the time line by using the parameters of the proceeding and following key-frames on the time line to determine the control on the image generating section 130.

In step ST46, the control section 140 determines whether the process has reached the time of the end time code. When the process has not reached the time of the end time code, the control section 140 returns to step ST34 and repeats the same process above. On the other hand, when the process has reached the time of the end time code, the control section 140 proceeds to the process in step ST47.

In step ST47, the control section 140 determines whether it is the final time in the meta time line. When it is not the final time, the control section 140 reads a start time code, an end time code and a preset speed (coefficient) in the next section in step ST48, and then the control section 140 returns to step ST44, and repeats the same process above. On the other hand, when it is the final time, the control section 140 terminates the control processing in step ST49.

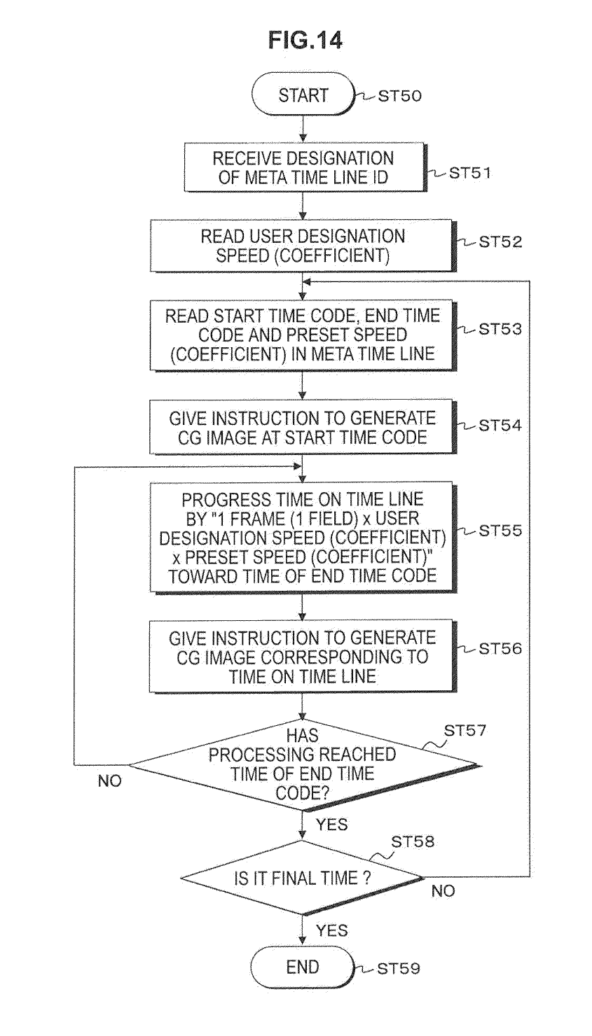

The flowchart in FIG. 12 shows the control operation in which no speed designation is given by the user through the operation on the speed designation section 152. The flowchart in FIG. 14 shows the control operation on the image generating section 130 made by the control section 140 when the speed designation is given by the user. In step ST50, the control section 140 starts the control operation and then proceeds to the process in step ST51.

In step ST51, the control section 140 receives a designation of the meta time line ID through the operation made by the user on the meta time line designation section 151. With this, the control section 140 gets into a controllable state of the operation in accordance with the meta time line corresponding to the designated meta time line ID in the predetermined number of meta time lines held by the meta time line holding section 170.

In step ST52, the control section 140 reads the user designation speed (coefficient). As described above, for example, the speed designation operation is previously made by the user on the speed designation section 152, and the user designation speed (coefficient) is held in the memory in the control section 140. In step ST52, the control section 140 reads the speed designation value held in the memory.

In step ST53, the control section 140 reads a start time code, an end time code and a preset speed (coefficient) in the first section of the meta time line. In step ST54, the control section 140 gives an instruction to the image generating section 130 to generate a CG image at the start time code.

In step ST55, the control section 140 progresses the time on the time line by “1 frame (1 field)×user designation speed (coefficient)×preset speed (coefficient)” toward the time of the end time code. In step ST56, the control section 140 gives an instruction to the image generating section 130 to generate a CG image corresponding to the time on the time line. When the time on the time line is not a key-frame, the control section 140 interpolates the parameters of the time on the time line by using the parameters of the proceeding and following key-frames on the time line to determine the control on the image generating section 130.

In step ST57, the control section 140 determines whether the processing has reached the time of the end time code. When the process has not reached the time of the end time code, the control section 140 returns to step ST55 and repeats the same process above. On the other hand, when the process has reached the time of the end time code, the control section 140 proceeds to the process in step ST58.

In step ST58, the control section 140 determines whether it is the final time in the meta time line. For example, when it is not the final time, the control section 140 returns to the process in step ST53, and reads a start time code, an end time code and a preset speed (coefficient) in the next section and repeats the same process above. On the other hand, when it is the final time, the control section 140 terminates the control processing in step ST59.

The flowchart in FIG. 14 shows the control operation corresponding to the control operation according to the flowchart hi FIG. 12. Although detailed description is omitted, the control operation according to the flowchart in FIG. 13 may include a user designation speed.

### 2. Second Embodiment

[Configuration of CG Image Generation Apparatus]

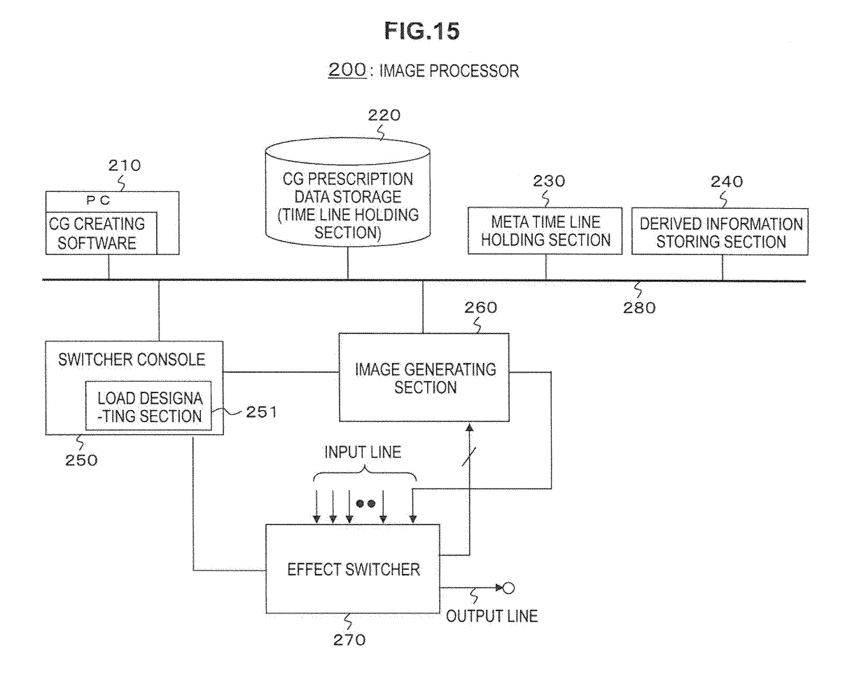

FIG. 15 illustrates an example of a configuration of an image processor 200 as a second embodiment of the present technology. The image processor 200 includes a CG (computer graphics) creating section 210, CG prescription data storage 220, a meta time line holding section 230 and a derived information storing section 240.

The image processor 200 also includes a switcher console (control section) 250, an image generating section 260 and an effect switcher 270. The CG creating section 210, the CG prescription data storage 220, the meta time line holding section 230, the derived information storing section 240, the switcher console 250 and the image generating section 260 are connected to each other via a network 280.

The CG creating section 210 is configured by a personal computer (PC) which has a CG creating software. The CG creating section 210 outputs CG prescription data of a predetermined format same as the CG creating section 110 of the image processor 100 in FIG. 1 As the format of the CG prescription data, for example, Collada (registered trademark) is applicable. The Collada is prescription definition for enabling 3D CG data exchange on an XML (Extensible Markup Language).

The CG prescription data storage 220 stores a predetermined number of CG prescription data which is generated with the CG creating section 210. The CG prescription data includes a time line (prescription of time-series changing control) of an original animation; i.e., an original time line (hereinafter, simply referred to as “time line”), in this view point, the CG prescription data storage 220 configures a time line holding section.

The derived information storing section 240 holds a derived information file. Plural derived information files can be created for one CG prescription data. The derived information file stores a predetermined number of derived information representing a content which is operative to the CG prescription data including parameters. The derived information includes at least a piece of parameter designation information or parameter value instruction information. The parameter designation information is the information for designating parameters to be adjusted which are to be adjusted by using the switcher console 250 in plural parameters included in the CG prescription data. The parameter value instruction information is the information for giving an instruction to adjust the parameters to be adjusted, which is included in the CG prescription data, to a predetermined value.

The meta time line holding section 230 holds a predetermined number of meta time lines (channel program) each of which prescribes a progression path on the time line. The meta time line holding section 230 is configured to hold plural meta time lines corresponding to each of the plural CG prescription data stored in the CG prescription data storage 220. The meta time line is for playing a part of the time line. A time-jump of time line may be included within the progression path on the time line prescribed in the meta time line. As the progression path on the time line prescribed in the meta time line, a progression path, in which time axis of the time line reverses, may be included.

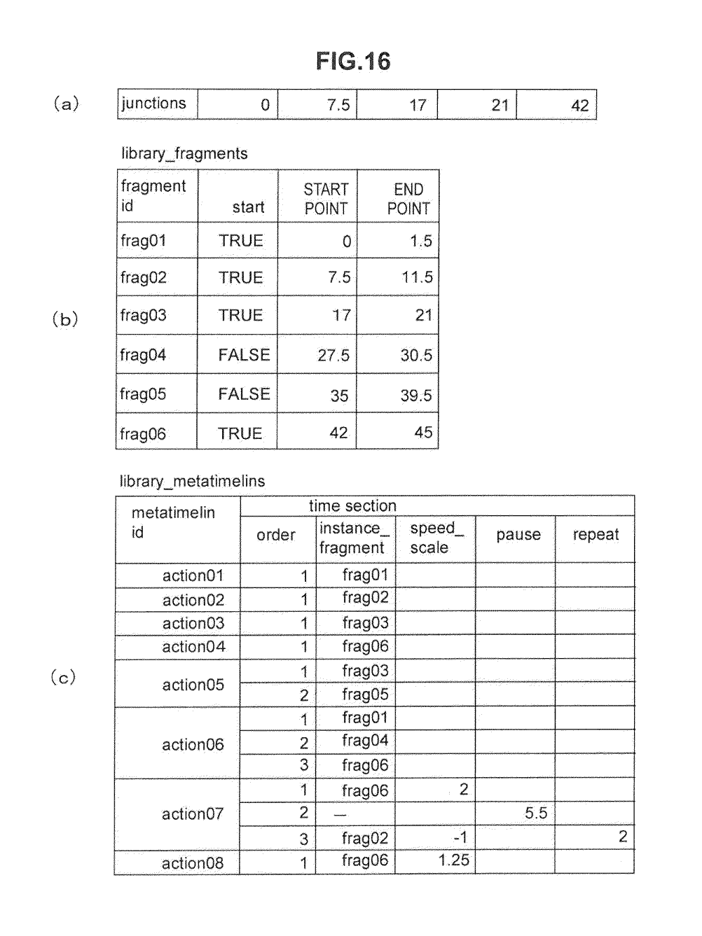

FIG. 16C shows an example of a meta time line held in the meta time line holding section 230 corresponding to one of the CG prescription data. In this example, the meta time line ID (metatimeline id) includes eight meta time lines from “action01” to “action08”. In each of the meta time lines, one or more fragments are arranged in permutation for enabling continuous play. Here, the fragment constitutes a part (fragment) of a time line. The fragment corresponds to the above-described section in the meta time line shown in FIG. 11.

FIG. 16B shows an example of a fragment constituting an example of a meta time line in FIG. 16C. In this example, the fragment ID (fragment id) includes six fragments from “frag01”to “frag06”. For example, in the fragment of “frag01”, the start point (start time) is “0”, and the end point is “1.5”. Also, in the fragment of “frag04” for example, the start point (start time) is “27.5”; and the end point is “30.5”. The start point and the end point of the fragment may not be a key-frame point; but may be such defined.

In FIG. 16B, an item “start” represents whether the start point (start time) of the fragment is a junction (connecting point). “TRUE” indicates the start point is a junction; and “FALSE” indicates the start point is not a junction. Here, the junction is a time (point) on a time line; and is a time (point) in which the CG space is identical. FIG. 16A shows an example of the junctions. Hereinafter, the fragment, in which the start point is a junction, will be arbitrarily referred to as “start fragment”.

Ordinary, the junction is positioned at a key-frame point. The junction may be positioned at another point than key-frame point. Since the points other than key-frame points are obtained as a result of interpolation, it is difficult to intentionally create a junction at a point other than key-frame point. When creating a CG, a junction is easily created by creating key-frame points each having a state identical to each other.

In this case, a junction can be extracted automatically from the time line. That is, when reading a piece of CG prescription data; i.e., when providing the data to the image generating section 260, by comparing key-frame points within a time line and by collecting key-frame points which have a state (parameter values) identical to each other, a junction can be extracted. For example, in the case when plural kinds which have a state identical to each other are found, a kind having a largest number of the state is determined as a junction. Or, since the head of the time line can be easily determined as a junction, when creating a CG, it may be configured so that a junction is determined by extracting key-frame points which have a state identical to that of the head of the time line.

As shown in FIG. 16C, in each meta time line, a start fragment, a start point of which is a junction, is determined as a head fragment. For example, the meta time line of “action01” is constituted of a single fragment of “frag01”. As shown in FIG. 16B, the fragment is a start fragment which has a junction at the start point. Also, for example, the meta time line of “action06” includes three fragments of “frag01” “frag04” and “frag06”. The head fragment of is a fragment of “frag01” which is a start fragment.

Each of the fragments constituting a meta time line may include a setting of reverse or speed. In FIG. 16C, an item “speed_scale” represents a piece of set information on reverse or speed. For example, “speed_scale=2” is set to a fragment of“frag06” at the head of the meta time line “action07”. In this case, in the meta time line of “action07”, the fragment of “frag06” is set so that the progression speed of the time on the time line is progressed at a speed two times faster than ordinary speed.

Also, for example, “speed_scale=−1” is set to a fragment of “frag02” in a meta time line of “action07”. In this case, in the meta time line of “action07”, the fragment of “frag02” is set so that the time on the time line progresses at an ordinary speed (1 times); but the time on the time line reverses from the end point toward the start point.

A pause may be set between the plural fragments constituting a meta time line. In FIG. 16C, an item “pause” represents a piece of information on pause time. In the meta time line of “action07”, a “pause=5.5” is set between the fragments of “frag06” and “frag02”. In this case, while playing a meta time line of “action07”, a pause for 5.5 seconds is interposed between the fragment of “frag06” and the fragment of “frag02”.

Also, a repeat may be set in each of the fragments constituting a meta time line. In FIG. 16C, an item “repeat” represents a piece of information on number of repeats. In the meta time line of “action07”, “repeat=2” is set to the fragment of “frag02”. In this case, while playing the meta time line of “action07”, the fragment of “frag02” is repeated two times.

In FIG. 16C, meta time line is represented is a chart form. Actual meta time line is prescribed in an XML format. For example, the meta time line of “action07” is prescribed in the XML format as shown below.

<metatimelineid=“action07”>
<timesection>
<order>1</order>
<speed_scale>2</speed_scale>
<instance_fragment url=“#frag06” />
</timesection>
<timesection>
<order>2</order>
<pause>5.5</pause> <!-- no fragment -->
</timesection>
<timesection>
<order>3</order>
<speed_scale>−1</speed_scale>
<repeat>2</repeat>
<instance_fragment url=“#frag02” />
</timesection>
</metatimeline>

The meta time line held by the meta time line holding section 230 is created by the switcher console 250 for example, or by another section; for example, by a personal computer or the like which has a software for creating meta time line and is connected to the network 280.

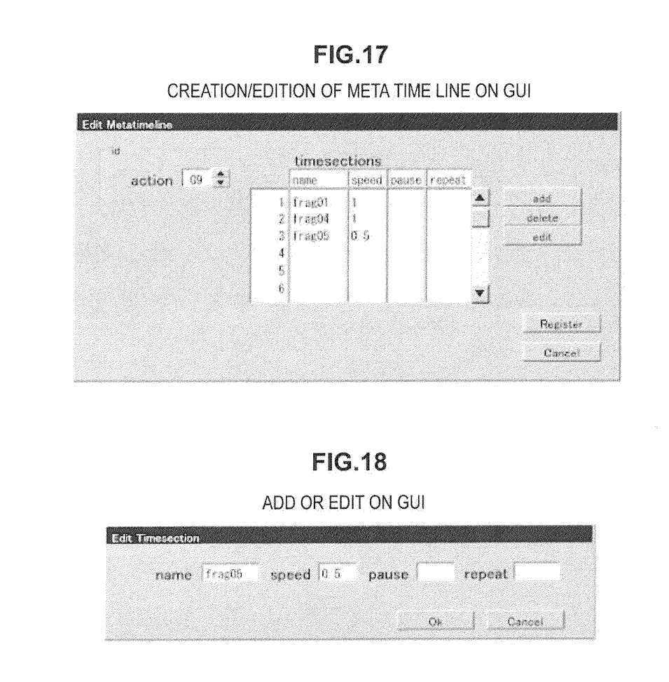

FIG. 17 shows an example of a graphical user interface (GUI) for creating/editing meta time line. By selecting a meta time line ID through the GUI, the user can perform creating/editing on a meta time line corresponding to the ID. By pressing “add” button, the user can add a fragment. By pressing “edit” button after selecting a predetermined fragment, the user can edit the predetermined fragment. By pressing “delete” button after selecting a predetermined fragment, the user can delete the predetermined fragment. By pressing “Register” button, the user can register a created or edited meta time line. On the other hand, by pressing “Cancel” button, the user can cancel a created or edited meta time line.

FIG. 18 shows an example of the GUI when the “add” or “edit” button is pressed by the user on the GUI shown in FIG. 17. Through the GUI, the user can create a fragment to be added or edit (change) a fragment by appropriately inputting data in the input section such as “name”, “speed”, “pause” or “repeat”. When “Ok” button is pressed, the created or edited fragment is established; and the GUI returns to the GUI screen shown in FIG. 17. On the other hand, when “Cancel” button is pressed, the created or edited fragment is canceled; and the GUI returns to the GUI screen shown in FIG. 17.

The GUI shown in FIG. 17 is for creating/editing of a meta time line which includes plural fragments. The GUI may be configured so that, for example, a GUI for creating/editing a meta time line having plural fragments and a GUI for creating/editing a meta time line having a single fragment are selectively presented to the user. In this case, by setting the GUI to display, for example, a screen for creating/editing a meta time line having a single fragment, the creating/editing can be limited to a meta time line having a single fragment.

The switcher console 250 receives an operation instruction input to the effect switcher 270. The switcher console 250 includes button rows (not shown in FIG. 15) for allowing ON/OFF operation of cross-point switches on the effect switcher 270. The switcher console 250 controls the image generating section 260. In this view point, the switcher console 250 functions as a control section.

The switcher console 250 includes a load designating section 251. The load designating section 251 reads a derived information file which is selected by the user through a selection operation from the derived information storing section 240, and provides the same to the image generating section 260. Also, the load designating section 251 reads a piece of CG prescription data, which is identified with an identifier included in the derived information file read from the derived 110 information storing section 240, from the plural CG prescription data stored in the CG prescription data storage 220, and provides the same to the image generating section 260.

Based on the parameter value instruction information included in the derived information file, the image generating section 260 adjusts a parameter to be adjusted, which is included in the CG prescription data, to a predetermined value. Also, the image generating section 260 sets a parameter designated by the parameter designation information in the plural parameters included in the CG prescription data, which is included in the derived information file, to a parameter adjusted by using the switcher console 250.

The image generating section 260 generates a CG image based on a piece of the CG prescription data provided by the load designating section 251. In this case, the switcher console 250 progresses the time on the time line which represents a position on the time line corresponding to the meta time line designated by the user from the plural meta time lines corresponding to the CG prescription data used by the image generating section 260 in the predetermined number of meta time lines held by the meta time line holding section 230. The switcher console 250 controls the time line operation; i.e., the generating operation of a CG image in accordance with the progression thereof.

The derived information file may include an instruction for texture-mapping on a polygonal surface in a CG. In this case, the image generating section 260 reads the instruction of texture-mapping from the derived information file and performs the texture-mapping of the image held therein on the designated polygonal surface. Or, when an instruction is written to perform texture-mapping on an input image, the image generating section 260 performs the texture-mapping on the designated surface of the input image.

Further, the derived information file may include data on every meta time lines (refer to FIG. 16C) corresponding to the relevant CG prescription data. In this case, the derived information storing section 240 is used as a meta time line holding section. In this case, even when different meta time lines are used for one CG prescription data, the management can be made easily. Also, in this case, even when the meta time line is used along with a method for varying the CG application by adjusting parameters, the meta time line can be managed easily at the application cite thereof.

The effect switcher 270 inputs plural image signals to select and combine the image signals. When broadcasting a live program, ordinarily, the effect switcher 270 is used to select an input camera in a studio, relay from external camera, VTR reproduction), to switch thereamong by wiping or to superimpose an image with a caption or picture-in-picture.

The effect switcher 270 has a plurality of input lines for inputting image signals. The output image signals from the image generating section 260 are input to any of the plural input lines. The effect switcher 270 includes an output bus line (auxiliary bus line) for providing an image for texture-mapping to the image generating section 260.

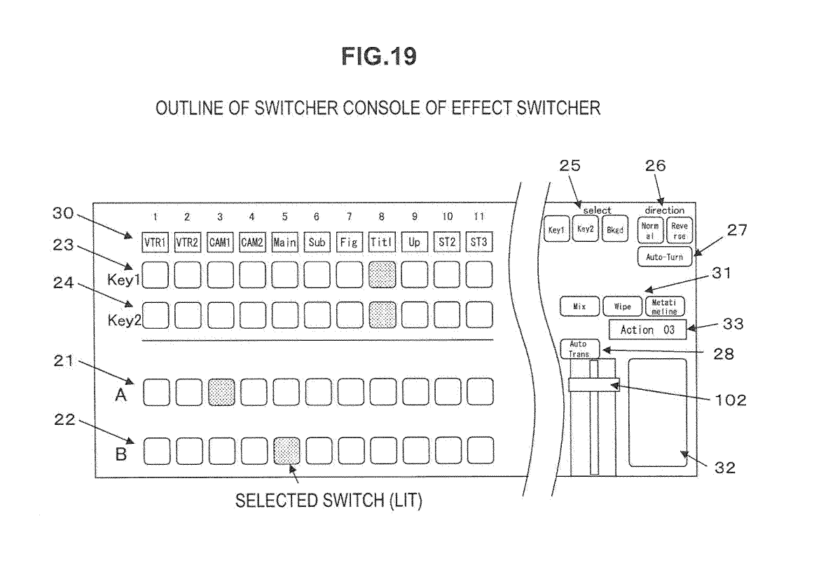

FIG. 19 illustrates an example of an exterior (operation plane) of the switcher console 250. Illustrated at the right side is an example of a block (group of operating elements) for operating the image combination/switching; i.e. transition. The next transition selection button 25 is used for determining the transition function to be controlled by this block. That is, the next transition selection button 25 designates the next transition to be played; i.e. an operation to switch (replace) between A-bus and B-bus of a background, or an operation to switch between On and Off on any keyer.

In another configuration, a dedicated block may be provided to each keyer without providing any operation elements like the next transition selection button 25 so that the dedicated block of each keyer receives the operation. Also, when plural signal processing circuits for performing transition are provided, a block may be configured so that each circuit receives the operation.

The switcher console 250 shown in FIG. 19 has keyers for two different lines: i.e. key 1 and key 2. Needless to say, the number of lines of the keyers may be larger or smaller than the above. The cross-point button rows 23 and 24 are used for selecting input images from the key 1 line and the key 2 line. Each of the cross-point button rows 21 and 22 is used for selecting an input image from the A-bus or B-bus of a background bus. The cross-point button row has a function to control to provide input signals (video) corresponding to a pressed button to the relevant bus.

Each of direction designating buttons 26 receives a designating operation when the progression manner of the transition is selectable between normal and reverse. An auto turn button 27 receives a designating operation to alternately switch between normal and reverse. A fader lever 102 is an operation element for manually operating the progression of the transition.

An AutoTrans button 28 instructs and triggers to automatically progress the transition (to progress the transition at preset time up to 100% in proportion to the time). Transition type selection buttons 31 are for selecting transition type. Here, the operation is selectable from Mix (to superimpose and combine all pictures at a ratio of one parameter). Wipe (to combine pictures while segmenting pictures based on a wiping pattern wave form) and Metatimeline (meta time line). A ten key input section 32 is a group of buttons for inputting numerals, pattern number of the wiping and number of meta time line.

Each of the above buttons may be configured including a character indication device on the surface and the function thereof is settable so that dynamic allocation of the function can be indicated on a display. A display 33 displays a wipe number or meta time line number given through the operation. A row of source name indicators 30 displays character information associated to an index number corresponding to the button number of the buttons disposed therebelow as shown in FIG. 19. The character information is stored in an unshown memory in the switcher console 250, and is settable by the user.

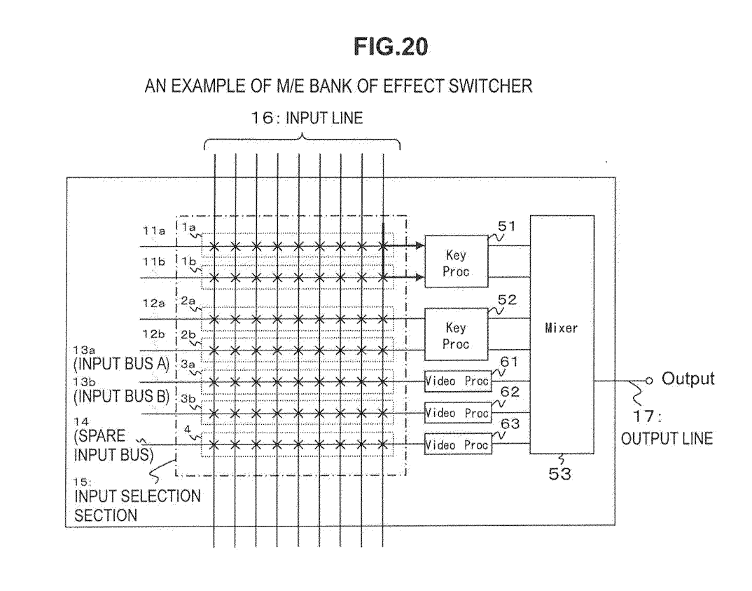

FIG. 20 illustrates an example of a configuration of an M/E bank of the effect switcher 270. The M/E bank includes an input selecting section 15, key processors (key processing circuit) 51 and 52, a mixer (image combining section) 53 and video processing sections 61-63. The file input selecting section 15 is configured to connect each of the input lines 16 to any of key source buses 11a and 12a, key fill buses 11b and 12b, a background-A bus 13a, a background-B bus 13b and a spare input bus 14.

Between each of the input lines 16 and the key source buses 11a and 12a, key source selecting switches 1a and 2a are provided to select a key source signal from plural image signals from the input lines 16. Also, between the each of the input lines 16 and key fill buses 11b and 12b, key fill selecting switches 1b and 2b are provided to select key fill signals from plural image signals from the input lines 16.

The key source signals, which are selected by the key source selecting switches 1a and 2a and take out to the key source buses 11a and 12a, are transmitted to the key processors 51 and 52. Also, the key fill signals, which are selected by the key fill selecting switches 1b and 2b and taken out to the key fill buses 11b and 12b, are transmitted to the key processors 51 and 52. The key fill signals are signals of an image to be superimposed with a background image as a foreground. The key source signals are signals to designate area to be superimposed with the key fill signals, a shape from which a background image is cut out, and a density of the key fill signals with respect to the background image or the like.

Between each of the input lines 16 and the background-A bus 13a, a background-A bus selection switch 3a is provided for selecting a background-A bus signal from the plural image signals on the input lines 16. Between each of the input lines 16 and the background-B bus 13b, a background-B selection switch 3b is provided for selecting a background-B signal from plural image signals on the input lines 16. Between each of the input lines 16 and the spare input bus 14, a spare input selection switch 4 is provided for selecting a spare input signal from plural image signals on the input line 16.

The background-A bus signal which is selected by the background-A bus selection switch 3a and taken out to the background-A bus 13a is transmitted to the mixer 53 via a video processing section 61. The background-B signal which is selected by the background-B selection switch 3b and taken out to the background-B bus 13b is transmitted to the mixer 53 via a video processing section 62. The spare input signal which is selected by the spare input selection switch 4 and taken out to the spare input bus 14 is transmitted to the mixer 53 via a video processing section 63.

The key processors 51 and 52 are circuits for adjusting/processing the key fill signal and the key source signal suitably for keying based on key adjusting values which are various kinds of parameters for performing the keying. The key adjusting values include the following values. That is, a value for adjusting the density of the key fill signal with respect to the background image; a value for adjusting a threshold value of the signal level of an image to be discriminate as a key source signal; a value for adjusting the position of the key source signal; a value for adjusting the reduction ratio of the key fill signal; an adjusting value on the border line with respect to the background image, and the like.

The key fill signal and the key source signal which has been adjusted/processed by the key processors 51 and 52 are transmitted to the mixer 53. The mixer 53 is a circuit which performs keying to superimpose a foreground image with a background image by using a key fill signal and key source signal from the key processors 51 and 52. A program output is output to the outside from the mixer 53 via the program output line 17.

[Operation and Control Action of Switcher Console]

The operation and control action of the switcher console 250 shown in FIG 19 will be described. When the image generating section 260 is not used; i.e. when the transition is made using “Mix” or “Wipe”, an object on which the transition is made with the next transition selection button 25 is selected first. This changes the function of each button in a block (group of operating elements) for performing the transition.

When selecting a picture to be used on a line as a transition object, the picture is selected by using a relevant cross-point button row. For example, when “CAM1” of the A-bus is presently used as a background, and then to transit the same to an image of “Main”, a “Main” cross point of the B-bus in the cross-point button row is pressed to select the same.

Either “Mix” or “Wipe” is selected using the transition type selection buttons 31. “Mix” changes gradually and uniformly the density of the superimpose on the entire picture. “Wipe” changes the segments of a picture by wiping. With this, the mode for combining pictures within the mixer 53 is switched between two modes; i.e. whether the density of entire picture is used or a key signal source of inner wiping waveform is used. There are several kinds (shape) of wiping patterns, which are designated using a number. The operator inputs a wiping pattern number through the ten key input section 32. Thus, the wiping waveform is changed.

By operating the fader lever 102, the combination ratio can be changed in a range from 0% to 100%. When a transition is made between the backgrounds A and B, the fader lever 102 is slid from either one of the original images (for example, A). The ratio of the other image (B) gradually increases, and when the fader lever 102 is swung up to the end thereof, an image (B) which is 100% different from the original image is generated. When the transition is made by operating the keyer from a non-superimposed image of the keyer, a superimposed image is obtained at the completion of the transition. Contrarily, when the transition is made by operating the keyer from a superimposed image, a non-superimposed image is obtained. When the wiping includes a direction in the shape or progression, the direction can be designated with the direction designating button 26.

[Control Procedure of Image Generating Section with the Switcher Console and Controlling]

The control procedure of the image generating section 260 with the switcher console 250 shown in FIG. 19 and controlling action will be prescribed. Firstly, a keyer to be used for taking a CG is designated using the next transition selection button 25. For example, the “Key1” is pressed down. Then, from the transition type selection buttons 31, the “Metatimeline” which represents a play of CG is pressed. When the “Metatimeline” is lit, a block (group of operating elements) for operating the transition and the relevant keyer “Key1” get ready to perform the control operation in combination with the image generating section 260.

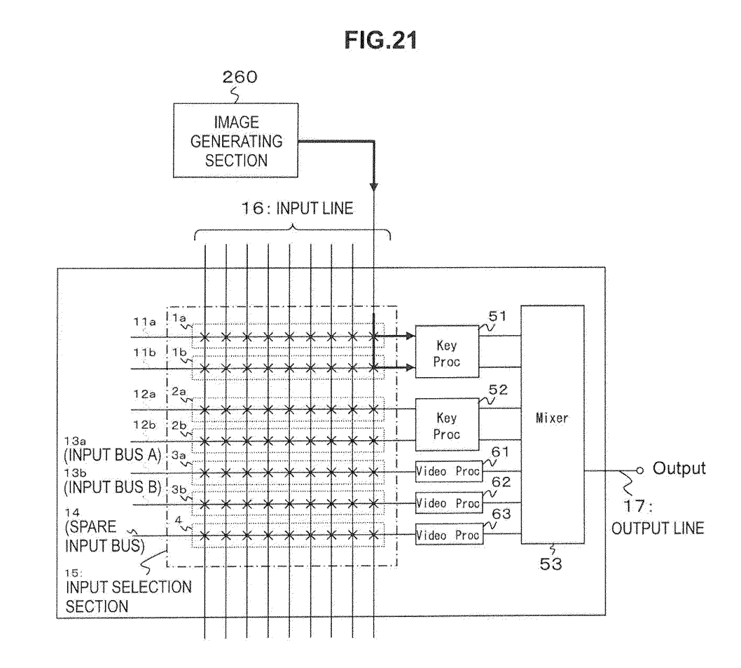

A number of the meta time line is input through the ten key input section 32. The number is a numerical value given at the end of the meta time line. For the “action01”, the value is 1. When received, the number is displayed on the display 33, and the image generating section 260 gets into a state to perform the rendering from the head of the meta time line having the number; i.e. to output the image at the head. The cross points on the effect switcher 270 are controlled to take the input which receives the image signal from the image generating section 260 into the relevant keyer “Key1” as shown in FIG. 21.

By operating the fader lever 102, the progression of the meta time line can be controlled using a parameter from 0 to 100%. That is, the position (time) on the meta time line to be rendered is determined by a percent with respect to the length of the meta time line. As a result, the CG image from the image generating section 260 can be used for combining in the effect switcher 270 using the keyer. When a unit for operating On/Off of the image on the keyer is otherwise provided, the superimposing of the image can be operated independently from the progression of the meta time line. It may be configured so that the relevant keyer is automatically turned On when the “Metatimeline” is pressed.

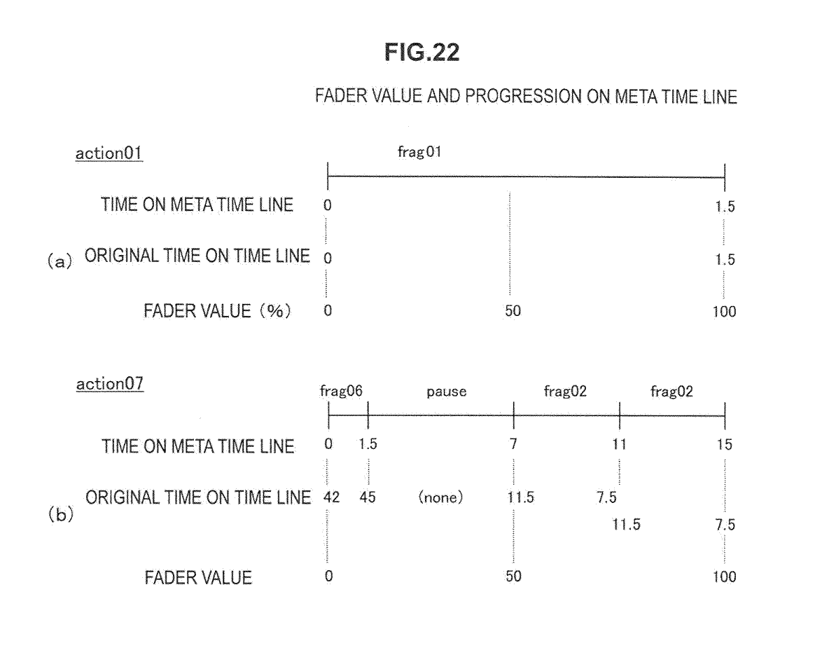

FIG. 22 illustrates an example of a relationship between the fader value and the progression on the meta time line. FIG. 22A shows a correlation among the time on the meta time line, the time on the time line (original time on the time line) and the fader value in the case of the meta time line of “action01” shown in FIG. 16C. FIG. 22B shows a correlation among the time on the meta time line, the time on the time line (original time on the time line) and the fader value in the case of the meta time line of “action07” shown in FIG. 16C. Here, in the time on the meta time line, the start time is 0; and the terminate time is the same value as the time length of the entire meta time line.

The operation of the fader lever 102 may be controlled so that the time on the meta time line is progressed 0-50% by the fist stroke; and then 50-100% by the second stroke. In the operation of the fader lever 102, the normal or reverse direction may be designated with the direction designating button 26.

The progress direction of the meta time line also can be controlled with the direction designating button 26. By setting the auto turn (Auto Turn) button 27 at “Auto Turn (also referred to as “Normal-Reverse”)”, when the meta time line is moved from the start point up to the end point, the meta time line progresses in a reversed direction from the end point toward the start point when the next progression instruction is given. During the progression, the direction of the progression can be desirably selected by operating the fader lever 102.

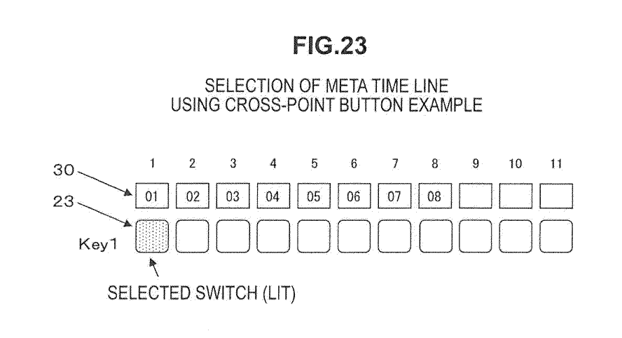

In the above-described example, the number of the meta time line is input through the ten key input section 32. However, in place of the ten key input section 32, the cross-point button row may be used. In this case, when the “Metatimeline” button is pressed, the cross-point button row of the relevant keyer “Key1” has a function to select the meta time line in place of its ordinary function. For example, the cross-point button row corresponds to, from the left button in order, the meta time lines of “action01”, “action02”, “action03”, . . . as shown in FIG. 23.

In this case, the user can select a desired meta time line by pressing the cross-point button row of “Key1”. Since the source name display 30 on the cross-point button row is shared with other row, a source name of the image signal is displayed. When it is configured so that number or name of the “Metatimeline” is displayed on the source name display 30 as shown in FIG. 23, it is recognizable more easily. Or it may be configured so that such display is activated only while the “Metatimeline” of the transition type selection buttons 31 is pressed. In the above example, the meta time line ID (Metatimeline id) is represented with action“number” (for example, “action01”) which is distinguished by the number. However, it may be configured so as to allow giving more tangible and preferred name.

When the M/E bank of the effect switcher 270 is capable of outputting a preview, it may be configured so that when the meta time line has progressed up to the end point, a preview is output for checking the output image on the M/E bank. When the meta time line is already at the end point, a preview when the meta time line is progressed from the end point up to the start point may be output. The preview is output at a point when the button of “Metatimeline” is pressed down (before the fader lever operation or the like is made). To enable such a preview, an image generating section, a circuit in the mixer and a bus line therefor are additionally provided.

[Control Operation when Meta Time Line is Designated as Transition Type]

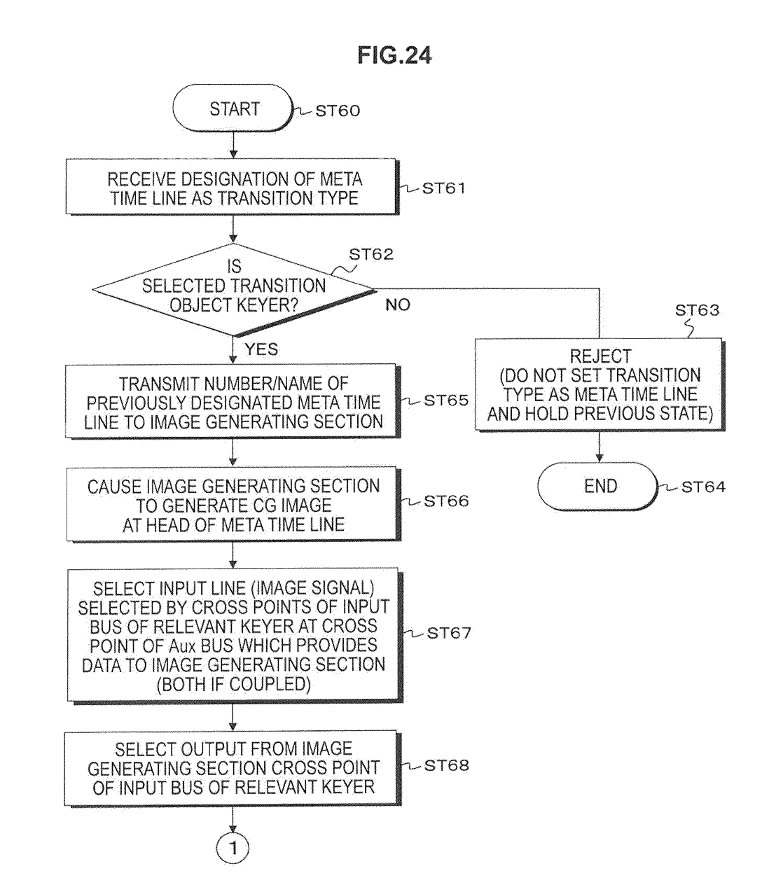

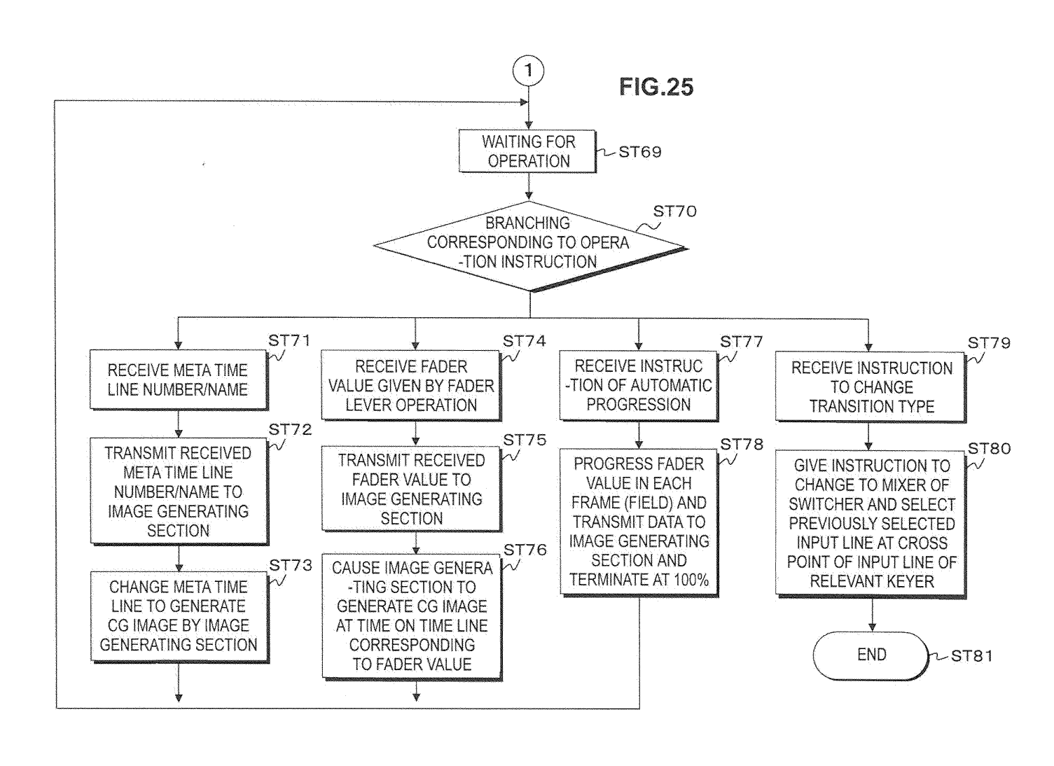

A description will be given on the control operation of the switcher console (control section) 250 when the “Metatimeline” button is pressed down and the meta time line is designated as transition type as described above with reference to the flowcharts in FIG. 24 and FIG. 25. In the following description, the switcher console 250 will be referred to as the control section 250.

In step ST60, the control section 250 starts the control operation. When the “Metatimeline” button is pressed, the control section 250 receives a designation of the meta time line as the transition type in step ST61. In step ST62, the control section 250 determines whether the transition object selected by the next transition selection button 25 is a keyer (“key1” or “key2”). When the selected transition object is not a keyer, the control section 250 rejects to determine the meta time line as the transition type and holds the previous state in step ST63. The control section 250 terminates the control operation in step ST64.

In step ST65, when the selected transition object is a keyer, the control section 250 proceeds the process. In step ST65, the control section 250 transmits a number or name of the previously designated meta time line to the image generating section 260. In step ST66, the control section 250 causes the image generating section 260 to generate a CG image at the head of the meta time line. An instruction is given to load a CG prescription data to be used corresponding to the meta time line, or the loading instruction is previously given.

Subsequently, in step ST67, the control section 250 selects an input line (image signal) selected by the cross points of the input bus of the relevant keyer at the cross point of auxiliary bus (Aux bus) which provides data to the image generating section 260. In this case, when the video and a key are coupled, the both are selected. In step ST68, the control section 250 selects to output from the image generating section 260 at the cross point of the input bus of the relevant keyer (refer to FIG. 21). The control section 250 waits for input of an operation in step ST69.

When an operation is made by the user (operator) in step ST70, the control section 250 makes a branching corresponding to the operation instruction. When the meta time line number or name is designated in step ST71, the control section 250 receives the meta time line number or name. In step ST72, the control section 250 transmits the received meta time line number or name to the image generating section 260 and changes the meta time line to generate a CG image by the image generating section 260 in step ST73. After that, the control section 250 returns to step ST69 and waits for next operation.

When the fader lever is operated in step ST74, the control section 250 receives a fader value. In step ST75, the control section 250 transmits the received fader value to the image generating section 260. In step ST76, the control section 250 causes the image generating section 260 to generate a CG image at the time on the time line corresponding to the fader value. After that, the control section 250 returns to step ST69 and waits for next operation.

When the AutoTrans button 28 is pressed in step ST77, the control section 250 receives an instruction of automatic progression of the transition. In step ST78, the control section 250 progresses the fader value in each frame (field) and transmits the data to the image generating section 260 to control the image generating section 260 to generate a CG image corresponding to the fader value. The control terminates when the fader value reaches 100%. After that, the control section 250 return to step ST69 and waits for next operation.

When the transition type is changed in step ST79, the control section 250 receives instruction about that. In step ST80, the control section 250 gives an instruction on the change to the mixer 53 in the effect switcher 270 to select the input line of the relevant keyer at the cross point. After that, the control section 250 terminates the control operation in step ST81.

[Change of Meta Time Line While Loop Playing]

A description will be given on the control operation of the switcher console (control section) 250 when an instruction is given to change to another meta time line while loop playing of a meta time line. The instruction of loop play of the meta time line is given by, for example, pressing a loop play button (not shown in FIG. 19) disposed in the switcher console (control section) 250. The selection changing operation of the meta time line is made by, for example, inputting a number of the another meta time line through the ten key input section 32, or by designating the another meta time line through the cross-point button row (refer to FIG. 23).

When receiving the instruction of meta time line change, the switcher console (control section) 250 switches to the instructed another meta time line at a timing when the loop play reaches the head of the meta time line. The play of the switched loop depends on the setting. With this, by changing the meta time line, the CG can be changed smoothly with no jump of image. By receiving the meta time line and a position therein, the image generating section 260 obtains the time on the previous time line (original time line). The image generating section 260 is configured to generate an image immediately in accordance with the parameter of a CG virtual space corresponding to the time (GoToTimecode operation).

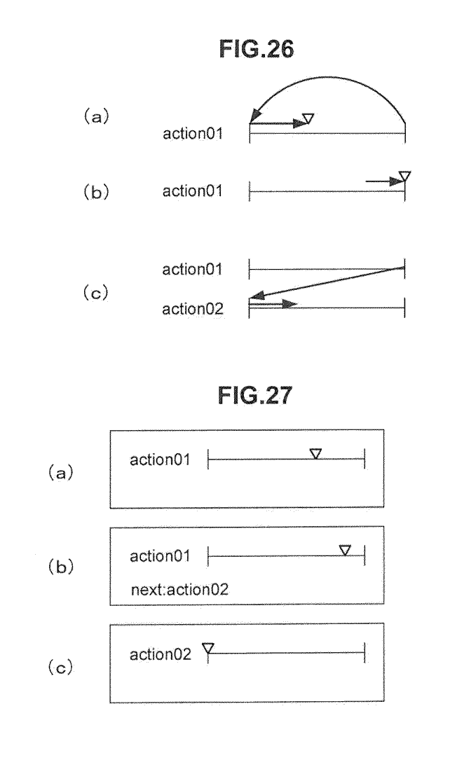

FIG. 26 schematically illustrates an example of a switching operation from meta time line in action. This example shows, for example, a meta time line change from “action01” to “action02”. FIG. 26A shows the meta time line “action01” in loop play; the switcher console (control section) 250 receives a instruction to change to the meta time line of “action02” while playing the meta time line.

As shown in FIG. 26B, the switcher console (control section) 250 plays the meta time line “action01” to the end thereof. In the next frame (field), the switcher console (control section) 250 changes the meta time line to the meta time line “action02” to generate an image as shown in FIG. 26C, and plays the meta time line from the head thereof.

FIG. 27 illustrates an example of a display of a time line during switching a meta time line in action. FIG. 27A illustrates a meta time line “action01” in play. When receiving a instruction to change to the meta time line “action02” while playing the meta time line, an indication appears shown in FIG. 27B. That is, the display indicates that the meta time line “action02” is now in play, and the next meta time line is “action01”. When the meta time line “action01” reaches the end, the meta time line of “action02” starts to play. At this time, it is indicated that the meta time line “action02” is in play as shown in FIG. 27C. In addition to ordinary loop play, a reciprocating play (ping pong operation) may be set to allow selection changing control of the meta time line while playing the reciprocating play.

[Explanation of Setting a Full Picture as a Junction]

In the above-description, junctions are key-frames or the like which have CG virtual spaces identical to each other. For the purpose of preventing an image from jumping, when the rendered images are identical to each other, the images can be used as a junction for connecting the meta time lines. In this case, a system is conceivable such that an image used for texture-mapping is transmitted to the image generating section 260 via the cross point of the effect switcher 270 in combination with the effect switcher 270 as shown in FIG. 15. In this case, such states that input images are displayed in a full picture after texture-mapping can be handled as the identical state.

Therefore, in the above-described example, plural key-frame points on the time line (original time line) which have identical CG spaces are handled as junctions, and are automatically extracted (aligned). Contrarily, key-frame points in which texture-mapped input images are displayed in a full-picture can be handled as a junction; that is, as a start point of a meta time line.

As for the control for achieving the above, for example, when plural planes to be texture-mapped are included in a virtual space defined by a CG prescription data, and when a key-frame point is adapted so that any one of the plural planes of just a full-picture is included, the plane is handled as a junction. While playing (in operation in combination with the switcher), each of the input images to texture-mapped is selected at the cross point of the effect switcher 270. For this purpose, the cross point is controlled so that, when a meta time line is changed and a transition is made from a full picture to another full picture, an image input to the switcher, which appears in the output image before the transition, is identical to an image input to the switcher which appears in the output image after the transition

That is, it is assumed that an auxiliary bus (Aux1) of the effect switcher 270 outputs an image of a texture-mapping plane-A; and an auxiliary bus (Aux2) of the effect switcher 270 outputs an image of a texture-mapping plane-B. When the output image is switched from the plane-A to the plane-B by switching the meta time line, the cross point is controlled so that input images identical to each other are obtained at the cross point of the auxiliary bus (Aux1) and the auxiliary bus (Aux2).

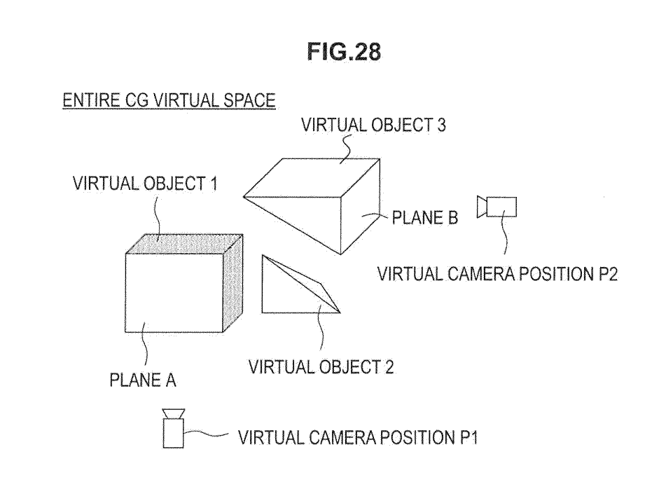

The prescription will be further made on handling a full picture as a junction. It is assumed that, for example, a space shown in FIG. 28 is prepared as a CG (computer graphics), a meta time line (Metatimeline) is created for creating an animation in which a virtual camera (view point) position shifts. Here, the virtual camera position P1 outputs an image of a plane-A of a virtual object “Object1” in just full-picture; and the virtual camera position P2 outputs an image of a plane-B of a virtual object “Object3” in just full-picture.

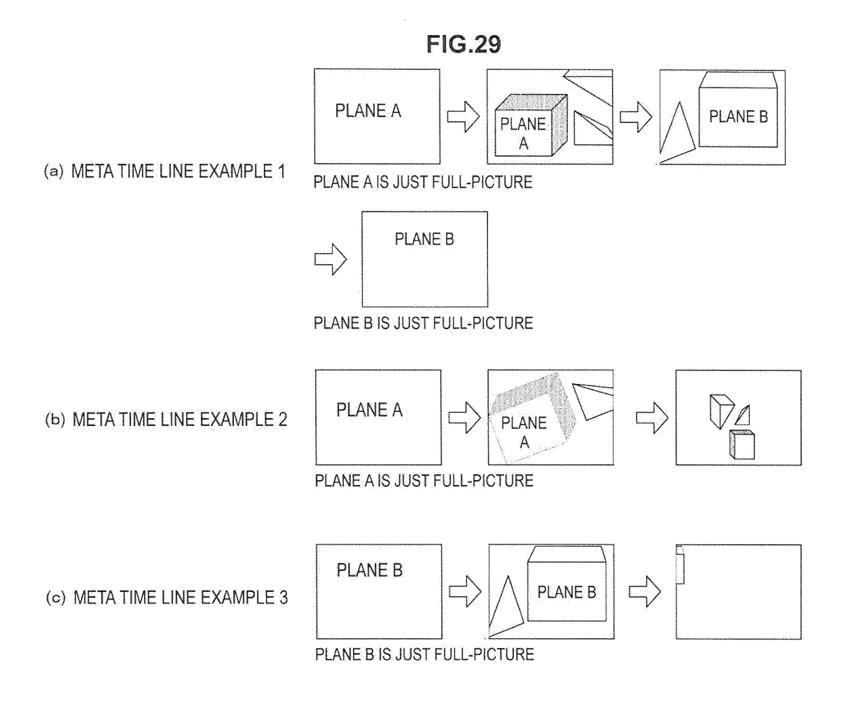

FIG. 29A illustrates a meta time line example 1. In the animation of the meta time line example 1, the virtual camera position starts from P1, an as the virtual camera shifts, the content of the output image changes and terminates at the state the plane-B becomes a full-picture. FIG. 29B illustrates a meta time line example 2. In the animation of the meta time line example 2, the virtual camera position starts from P1, and as the virtual camera shifts, the content of the output image changes, the virtual camera shifts far away from the virtual object while rotating, and terminates including the reduced virtual object. FIG. 29C illustrates a meta time line example 3. In the animation of the meta time line example 3, the virtual camera position starts from P2, and as the virtual camera shifts, the content of the output image changes, and terminates including the reduced virtual object.

Each of the meta time lines is in a first state (head of the meta time line) immediately after being selected. When the meta time lines is progressed (played), the animation acts in accordance with the meta time line. When the meta time line reaches the end thereof, the meta time line stops and terminates. The meta time line can be progressed reversely to return to the head thereof. Such action can be controlled by the fader lever.

Since the first state of the meta time line example 1 is exactly identical to the first state of the meta time line example 2, the meta time line can be transited to the other state by switching from any state. On the other hand, the first state of the meta time line example 2 and the first state of the meta time line example 3 are different from each other in a state of the virtual space including the virtual camera. Because a strange sensation is caused, it is difficult to switch from the first state of the meta time line example 2 to the meta time line example 3.

However, the switching is made possible by handling a state texture-mapped in a full-picture as a junction. In this case, the action to transit from the meta time line example 2 to the meta time line example 3 at the head of the meta time line is as described below. That is, an image (input image), which is texture-mapped in the plane-A is texture-mapped in the plane-B, and then the image is switched to the meta time line example 3.

Detailed description will be made on the handling of the image (video signal). It is assumed that the effect switcher 270 is configured so that an input image to be texture-mapped in a plane-A is provided from the auxiliary bus “Aux1” and an input image to be texture-mapped in a plane-B is provided from an auxiliary bus “Aux2”. The cross point circuit (cross point of auxiliary bus of the effect switcher 270) is configured to select either an image (video signal) output from the auxiliary bus “Aux1” or an image (video signal) output from the auxiliary bus “Aux2”.

The transition action from the meta time line example 2 to the meta time line example 3 at the head of the meta time line is as described below. That is, at the point of the transition, the cross point circuit is controlled so that the image provided to the auxiliary bus “Aux1” from the cross point circuit is provided also to the auxiliary bus “Aux2”. Since the state the same image appears in fill-picture is kept, by switching the meta time line, the meta time line can be switched without giving viewers awareness of the switching. By progressing the meta time line from that point, an animation different from that before switching can be obtained.

As another application of the control, by utilizing a state that an input image is in full-picture, the meta time line can be switched regardless of the junction. For example, such control is possible that the end of the meta time line example 1 is switched to the head of the meta time line example 2 without being recognized by viewers.

When the cross point is not controlled, when the generation of image is switched from the end of the meta time line example 1 to the head of the meta time line example 2, the content changes. Because, the image (full-picture) texture-mapped in the plane-B is switched to the image (full-picture) texture-mapped in the plane-A. However, at the point of the transition, by controlling the cross point circuit so that the image provided to auxiliary bus “Aux2” is also provided to the auxiliary bus “Aux1”; and then by switching the meta time line, the state in which same image is displayed in full-picture is kept.

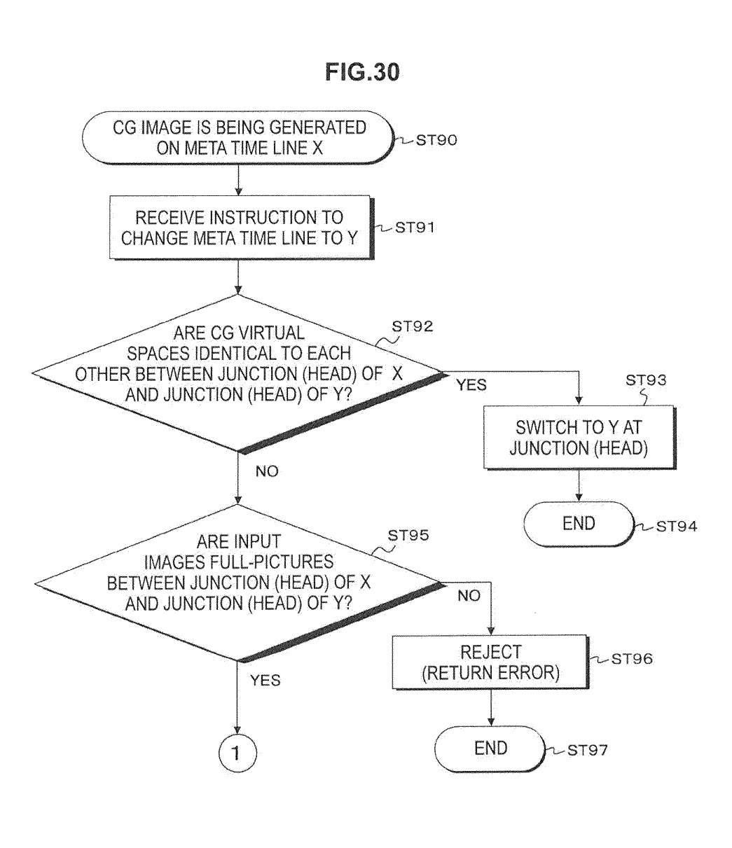

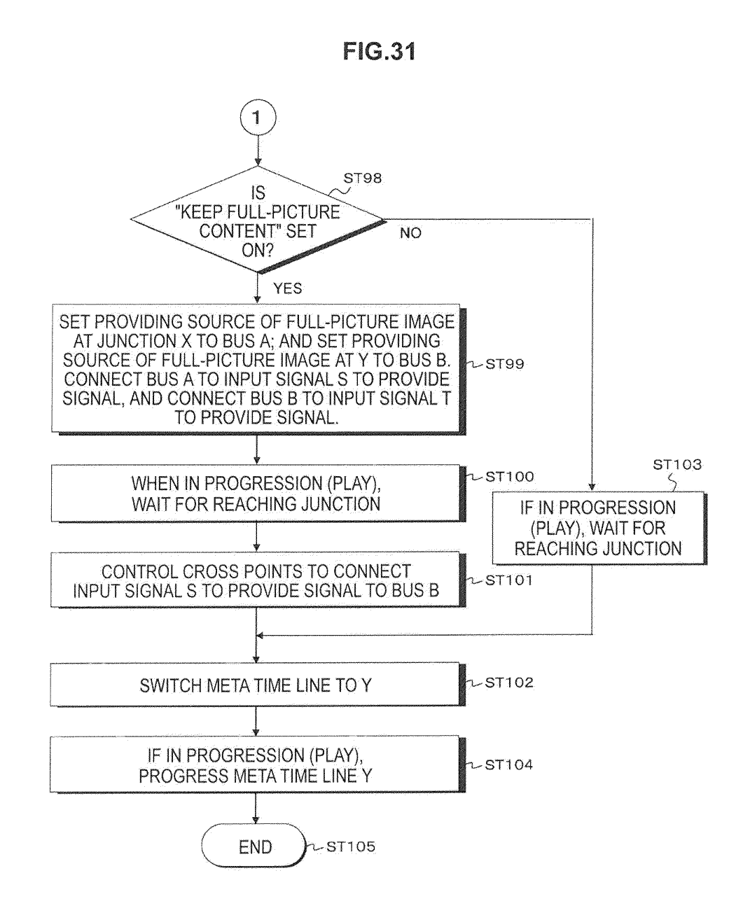

FIG. 30 and FIG. 31 are flowcharts showing the switching control operation of the meta time line in the switcher console (control section) 250 when On/Off of “keep full-picture content” is set as option. When the option set of “keep full-picture content” is stored and when it is On, a control is made to keep the content of full-picture image as described above; but when it is Off, the control is not made. Hereinafter, the switcher console 250 is referred to as the control section 250 and description will be made below.

In step ST90, while a CG image is being generated on a meta time line X, the control section 250 starts the control operation. Then, in step ST91, the control section 250 receives an instruction to change the meta time line to a meta time line Y. In step ST92, the control section 250 determines whether the CG virtual spaces are identical to each other between the junction (head) of the meta time line X and the junction (head) of the meta time line Y.

When the CG virtual spaces are identical to each other, the control section 250 switches the meta time line to the meta time line Y at the timing of junction (head) of the meta time line X in step ST93. The control section 250 terminates the control operation in step ST94. On the other hand, when the CG virtual spaces are not identical to each other, the control section 250 proceeds to the process in step ST95.

In step ST95, the control section 250 determines whether both of the junction (head) of the meta time line X and the junction (head) of the meta time line Y has an input image of full-picture state. When the input images are not full-picture state, the control section 250 rejects the instruction to switch from the meta time line X to the meta time line Y in step ST96, and terminates the control operation in step ST97. On the other hand, when the input images are full-picture state, the control section 250 proceeds to the process in step ST98.

In step ST98, the control section 250 determines whether the “keep full-picture content” is set On. When the set is On, the control section 25 proceeds to the process in step ST99. In step ST99, the control section 250 sets a providing source of the full-picture image at the junction on the meta time line X to a bus A; and sets a providing source of the full-picture image at the junction on the meta time line Y to a bus B. In this case, at the cross points, the bus A is connected to an input signal S to provide the same, and the bus B is connected to an input signal T to provide the same.

When the meta time line X is in progression (Play), the control section 250 waits for the meta time line X reaching the junction in step ST100. After that, the control section 250 controls the cross points to connect the input signal S of the bus B to provide the same in step ST101. Then, the control section 250 proceeds to the process in step ST102.

When the set is not On in step ST98, the control section 250 proceeds to the process in step ST103. In step ST103, when the meta time line X is in progression (play), the control section 250 waits for the meta time line X reaching the junction. After that, the control section 250 proceeds to the process in step ST102. When the meta time line X reaches the junction (head) in step ST102, the control section 250 switches the meta time line to the meta time line Y.

When the meta time line X is in progression (play), the control section 250 progresses the meta time line Y in step ST104. After that, the control section 250 terminates the control operation in step ST105.

As another application, a method in which, in place of the full-picture, the transition is made by using the area in an input image in a picture (texture-mapped area) which is identical state (a state CG portions are different from each other) is also possible.

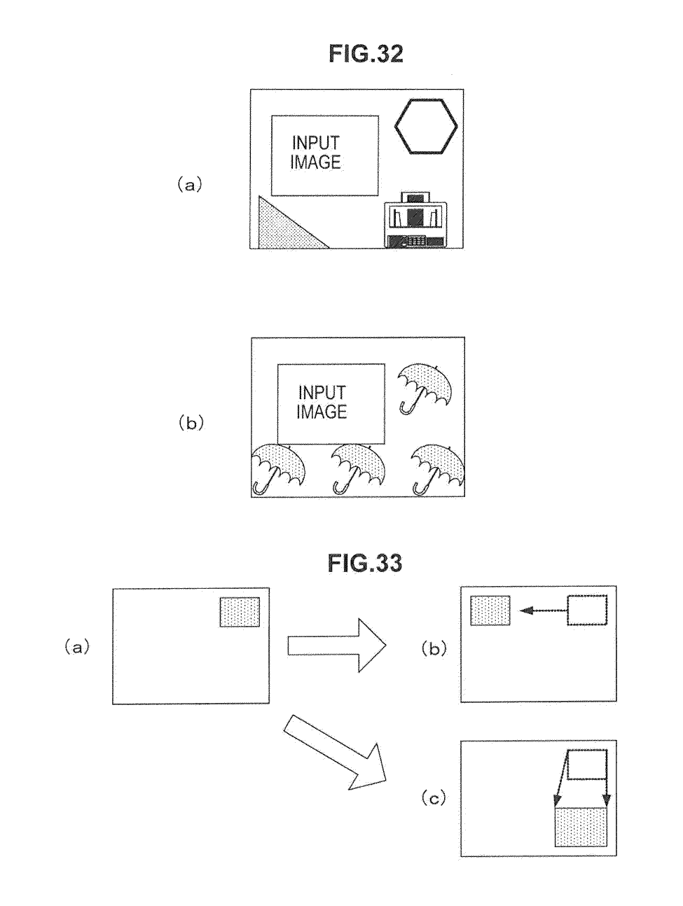

When a transition of a picture content is made as shown in FIG. 32A and FIG. 32B by switching the meta time line, the control is made to keep the content of a part of the input image as described above, same as when the input image is full-picture. With this, it is easy to give the viewers an impression that only a CG “decollation” is changed. Even when the input image is not full-picture, the above is achieved by making the above control on the input image included in the output image. In this case, with respect to an input image which is not full-picture but appears in picture of the output image, the cross point is controlled so that the content is kept in accordance with switching of the CG content. An input image which appears in a picture can be identified (determination whether an object is included in a picture) with a known technique.

[Control of Cross Point and Timing of CG Switching (Meta Time Line Switching)]

The timing when an image signal provided from the cross point circuit to the image generating section 260 actually enters into an output CG image; i.e. texture-mapped after a delay equivalent to a time taken for generating the image. For example, an input image signal becomes an element of an output image of 2 frames behind. As a result, it takes a time equivalent to 2 frames from a point when an input image signal is switched by the cross point circuit to a point when the same is reflected on the output CG image. Also, for example, it takes for the image generating section 260 a time delay equivalent a 1 frame to change a CG content from an instruction is received.

As described above, to simultaneously control the cross points and content change (switch of meta time line etc) of a CG by the image generating section 260, the control is made while considering the timing gap. For example, in the case of the above, it is arranged so that the instruction to switch the cross point is transmitted to the image generating section 260 after a time equivalent to 1 frame.

[Use of Joystick]

Since plural meta time lines has an identical state at the head (junction), the progression (play) starts at the same time when an operator (user) selects a desired meta time line. For example, a joystick is available as an input operation unit. It may be configured so that, depending on the operation made using the joystick, the meta time line is selected; and upon receipting of the operation, the meta time line and the progression are made.

The operation of the joystick is sorted as, (1) tilt forward, (2) tilt backward, (3) tilt leftward, (4) tilt rightward, (5) turn clockwise, and (6) turn counterclockwise, for example. An operation is recognized as any one of the above, and a meta time line is selected in accordance with the operation to start the progression. The switcher console (control section) 250 stores a table below which associates the operations and the meta time lines.

tilt forward: action01
tilt backward: action02
tilt leftward: action03
tilt rightward: action04
turn clockwise: action05
turn counterclockwise: action06

As described above, in the image processor 200 shown in FIG. 15, the switcher console (control section) 250 progresses the time on the time line representing a position on the time line in accordance with the meta time line designated by the user. The switcher console (control section) 250 controls a CG image generating operation (time line operation) by the image generating section 260 in accordance with the progression.

As described above, the progression path on the time line prescribed in the meta time line may include a time-jump of time line therein. Also, as described above, a progression path which reverses on the time axis of the time line may be included as a progression path within the time line prescribed in the meta time line. Also, a speed may be set in each of the fragments constituting a meta time line. Also, the number of repeats may be set in each of the fragments constituting the meta time line. Further, a pause may be set between the fragments constituting a meta time line. With this, same as the image processor 100 shown in FIG. 1, the operability of complicated time-series motions is enhanced.

In the image processor 200 shown in FIG. 15, the head of plural meta time lines is adapted so as, for example, to position on the time line at a point of time the contents within a CG space are identical to each other, or at a point of time when the input image to be texture-mapped is full-picture. The switcher console (control section) 250 is configured so as, when an instruction is given to switch from a first meta time line in play to a second meta time line, to switch the first meta time line to the second meta time line when the first meta time line reaches the head thereof. Accordingly, when the meta time line is switched, the CG can be changed smoothly with no jump in the image.

Also, in the image processor 200 shown in FIG. 15, when the heads of the first and second meta time lines positioned at a point of time when an input image to be texture mapped is full-picture, the switcher console (control section) 250 controls as described below. That is, when switching from the first meta time line to the second meta time line, the switcher console (control section) 250 controls the image generating section so that the input images to be texture mapped are identical to each other. Accordingly, when the meta time line is switched, the CG can be changed smoothly with no jump in the image. Also, in the image processor 200 shown in FIG. 15, the meta time line may be set to perform loop play.

### 3. Modification

In the above embodiment, an example in which the present technology is applied to the image processor which creates a CG image on a live program has been prescribed. However, it is needless to say that the present technology is applicable to other apparatuses which perform like time line operation.

Additionally, the present technology may also be configured as below.
(1) A time line operation control device, including:

a time line holding section that holds a time line which is a prescription of a time-series changing control;

a meta time line holding section that holds a meta time line prescribing a progression path on the time line; and

a control section that progresses time on the time line representing a position on the time line in accordance with the progression path on the time line prescribed in the meta time line to thereby control the time line operation in accordance with the progression.
(2) The time line operation control device according to (1), wherein

when an instruction, is given to play the meta time line, the control section changes the time on the time line to a value which is designated to the head on the meta time line.
(3) The time line operation control device according to (1) or (2), wherein

the progression path on the time line prescribed in the meta time line is able to include a time-jump of the time line.
(4) The time line operation control device according to any one of (1) to (3), wherein

when the time on the time line is between key-frame points on the time line, the control section interpolates parameters of the time on the time line by using parameters of the proceeding and following key-frames to thereby determine the control.
(5) The time line operation control device according to any one of (1) to (4), wherein

the progression path on the time line prescribed in the meta time line is able to be a progression path which reverses on the time axis of the time line.
(6) The time line operation control device according to any one of (1) to (5), wherein

the meta time line holding section holds a plurality of meta time lines, and

the control section controls the time Fine operation based on one meta time line selected from the plurality of meta time lines.
(7) The time line operation control device according to any one of (1) to (6), wherein

the control section progresses the time on the time line representing a position on the time line in accordance with the progression path on the time line prescribed in the meta time line and a user designation speed to thereby control the time line operation in accordance with the progression.
(8) The time line operation control device according to any one of (1) to (6), wherein

the progression path on the time line prescribed in the meta time line includes a predetermined number of sections each including a preset speed, and

the control section progresses the time on the time line which represents a position on the time line based on the progression path on the time line prescribed in the meta time line and the preset speed of each section to thereby control the time line operation in accordance with the progression.
(9) The time line operation control device according to any one of (1) to (6), wherein

the progression path on the time line prescribed in the meta time line includes a predetermined number of sections each including a preset speed, and

the control section progresses the time on the time line which represents a position on the time line based on the progression path on the time line prescribed in the meta time line, the preset speed of each section and a user designation speed to thereby control the time line operation in accordance with the progression.
(10) The time line operation control device according to any one of (1) to (9), further including

a meta time line creating support section that supports the creation of the meta time line, wherein

the meta time line creating support section detects identical contents with respect to a plurality of key-frame points in the time line to present the same as an option of a progression start point of the meta time line.
(11) The time line operation control device according to any one of (1) to (1), wherein

the control section progresses the time on the time line which represents a position on the time line in accordance with the progression path on the time line prescribed in the meta time line and a fader value provided by a fader lever operation to thereby control the time line operation in accordance with the progression.
(12) A time line operation control method, including:

progressing time on a time line which represents a position on the time line as a prescription of a time-series changing control in accordance with a meta time line which prescribes a progression path on the time line to thereby control the time line operation in accordance with the progression.
(13) A program that causes a computer to function as

a time line holding unit that holds a time line which is a prescription of a time-series changing control;

a meta time line holding unit that holds a meta time line prescribing a progression path on the time line; and

a control unit that progresses time on the time line representing a position on the time line in accordance with the progression path on the time line prescribed in the meta time line to thereby control the time line operation in accordance with the progression.
(14) An image processor, including:

an image generating section that generates an image based on a piece of computer graphics prescription data including a time line operation;

a meta time line holding section that holds a meta time line prescribing a progression path on a time line; and

a control section that progresses time on the time line representing a position on the time line in accordance with the progression path on the time line prescribed in the meta time line to thereby control the image generating section to play a part of the time line in accordance with the progression.
(15) The image processor according to (14), wherein

the meta time line holding section holds a plurality of meta time lines, and

a head of the plurality of meta time lines is a point of time when computer graphics spaces are identical to each other on the time line and/or when an input image to be texture mapped is full-picture.
(16) The image processor according to (15), wherein,

when an instruction is given to switch a first meta time line in play to a second meta time line, the control section switches from the first meta time line to the second meta time line when the first meta time line reaches the head thereof.
(17) The image processor according to (16), wherein

the heads of the first meta time line and the second meta time line are a point of time on the time line when an input image to be texture mapped is full-picture, and

when switching from the first meta time line to the second meta time line, the control section controls to provide a texture mapping image to the image generating section so that the input images to be texture-mapped are identical to each other.

The present disclosure contains subject matter related to that disclosed in Japanese Priority Patent Application JP 2011-177230 filed in the Japan Patent Office on Aug. 12, 2011, the entire content of which is hereby incorporated by reference.

What is claimed is:

1. A time line operation control device, comprising:
a time line holding section that holds a time line which is a prescription of a time-series changing control;
a meta time line holding section that holds a meta time line prescribing a progression path on the time line; and
a control section that progresses time on the time line representing a position on the time line in accordance with the progression path on the time line prescribed in the meta time line to thereby control the time line operation in accordance with the progression.

2. The time line operation control device according to claim 1, wherein
when an instruction is given to play the meta time line, the control section changes the time on the time line to a value which is designated to the head on the is meta time line.

3. The time line operation control device according to claim 1, wherein
the progression path on the time line prescribed in the meta time line is able to include a time-jump of the time line.

4. The time line operation control device according to claim 1, wherein
when the time on the time line is between key-frame points on the time line, the control section interpolates parameters of the time on the time line by using parameters of the proceeding and following key-frames to thereby determine the control.

5. The time line operation control device according to claim 1, wherein
the progression path on the time line prescribed in the meta time fine is able to be a progression path which reverses on the time axis of the time line.

6. The time line operation control device according to claim 1, wherein
the meta time line holding section holds a plurality of meta time lines, and
the control section controls the time line operation based on one meta time line selected from the plurality of meta time lines.

7. The time line operation control device according to claim 1, wherein
the control section progresses the time on the time line representing a position on the time line in accordance with the progression path on the time line prescribed in the meta time line and a user designation speed to thereby control the time line operation in accordance with the progression.

8. The time line operation control device according to claim 1, wherein
the progression path on the time line prescribed in the meta time line includes a predetermined number of sections each including a preset speed, and
the control section progresses the time on the time line which represents a position on the time line based on the progression path on the time line prescribed in the meta time line and the preset speed of each section to thereby control the time line operation in accordance with the progression.

9. The time line operation control device according to claim 1, wherein
the progression path on the time line prescribed in the meta time line includes a predetermined number of sections each including a preset speed, and
the control section progresses the time on the time line which represents a position on the time line based on the progression path on the time line prescribed in the meta time line, the preset speed of each section and a user designation speed to thereby control the time line operation in accordance with the progression.

10. The time line operation control device according to claim 1, further comprising
a meta time line creating support section that supports the creation of the meta time line, wherein
the meta time line creating support section detects identical contents with respect to a plurality of key-frame points in the time line to present the same as an option of a progression start point of the meta time line.

11. The time line operation control device according to claim 1, wherein
the control section progresses the time on the time line which represents a position on the time line in accordance with the progression path on the time line prescribed in the meta time line and a fader value provided by a fader lever operation to thereby control the time line operation in accordance with the progression.

12. A time line operation control method, comprising:
progressing time on a time line which represents a position on the time line as a prescription of a time-series changing control in accordance with a meta time line which prescribes a progression path on the time line to thereby control the time fine operation in accordance with the progression.

13. A program that causes a computer to function as
a time line holding unit that holds a time one which is a prescription of a time-series changing control;
a meta time line holding unit that holds a meta time line prescribing a progression path on the time line; and
a control unit that progresses time on the time line representing a position on the time line in accordance with the progression path on the time line prescribed in the meta time line to thereby control the time line operation in accordance with the progression.

14. An image processor, comprising:
an image generating section that generates an image based on a piece of computer graphics prescription data including a time line operation;
a meta time line holding section that holds a meta time line prescribing a progression path on a time line; and
a control section that progresses time on the time line representing a position on the time line in accordance with the progression path on the time line prescribed in the meta time line to thereby control the image generating section to play a part of the time line in accordance with the progression.

15. The image processor according to claim 14, wherein
the meta time line holding section holds a plurality of meta time lines, and
a head of the plurality of meta time lines is a point of time when computer graphics spaces are identical to each other on the time line and/or when an input image to be texture mapped is full-picture.

16. The image processor according to claim 15, wherein,
when an instruction is given to switch a first meta time line in play to a second meta time line, the control section switches from the first meta time line to the second meta time line when the first meta time line reaches the head thereof.

17. The image processor according to claim 16, wherein
the heads of the first meta time line and the second meta time line are a point of time on the time line when an input image to be texture mapped is full-picture, and
when switching from the first meta time line to the second meta time line, the control section controls to provide a texture mapping image to the image generating section so that the input images to be texture-mapped are identical to each other.
